(19) United States
(12) Patent Application Publication
(10) Pub. No.: US 2025/0064085 A1
(43) Pub. Date: Feb. 27, 2025

(54) SOY PROTEIN CONCENTRATES AND METHODS OF PRODUCING AND USING THEREOF

(71) Applicant: Benson Hill, Inc., St. Louis, MO (US)

(72) Inventors: Keith PETROFSKY, St. Louis, MO (US); Kip UNDERWOOD, Town and Country, MO (US); Jason F. LOMBARDI, St. Charles, MO (US); Michael W. GIBSON, Decatur, IL (US); Savitha G. CHELLADURAI, Chicago, IL (US); Trent L. COLLINS, Lake Saint Louis, MO (US); Anthony J. KINGSLEY, Chicago, IL (US); Ali RASHID NIAGHI, Vadnais Heights, MN (US); Dustin A. BRUCKER, Ankeny, IA (US)

(73) Assignee: Benson Hill, Inc., St. Louis, MO (US)

(21) Appl. No.: 18/724,345

(22) PCT Filed: Dec. 29, 2022
(86) PCT No.: PCT/US2022/082559

§ 371 Date: Jun. 26, 2024

Related U.S. Application Data
(60) Provisional application No. 63/424,788, filed on Nov. 11, 2022.
(60) Provisional application No. 63/295,366, filed on Dec. 30, 2021.

(51) Int. Cl. A23J 3/16; A23J 1/14; A23J 3/26; A23L 11/30; A23L 33/185

(52) U.S. Cl. CPC A23J 3/16; A23J 1/142; A23J 3/26; A23L 11/32; A23L 33/185

(57) ABSTRACT

The present disclosure relates generally to soybean products derived from high protein soybeans, and more specifically to soybean compositions having high protein content and methods of preparing and using such protein enriched soybean compositions. The present disclosure also relates to uses of the protein enriched soybean compositions in food products.

### CROSS-REFERENCE TO RELATED APPLICATIONS

This application claims priority to and the benefit of U.S. Provisional Application No. 63/295,366, filed on Dec. 30, 2021, and U.S. Provisional Application No. 63/424,788, filed on Nov. 11, 2022, the disclosures of each of which are incorporated herein by reference in their entireties.

### FIELD

The present disclosure relates generally to soybean products derived from high protein soybeans, and more specifically to soybean compositions having high protein content and methods of preparing and using such soybean compositions. The present disclosure also relates to uses of the soybean compositions in food products.

### BACKGROUND

Soybeans represent an attractive renewable source of protein for use in foodstuffs. However, the protein content of unprocessed soybeans is too low for many product applications. Further, unprocessed soybeans can contain unacceptably high concentrations of unwanted components, such as intrinsic oligosaccharides stachyose and raffinose, which are typically removed through processing before the soy compositions can be used in certain products.

High protein content soy ingredients are desirable for a variety of food products and applications. High protein soy ingredients are desirable for their nutritional properties, as well as the functional properties derived from their protein content. These functional properties are the intrinsic physicochemical characteristics which affect the behavior of a food ingredient in food systems during processing, manufacturing, storage and preparation. Such functional properties include water holding, oil binding, emulsification, foam capacity, gelation, whipping capacity, viscosity and others. Functional properties are important in determining the quality (nutritional, sensory, physicochemical and organoleptic properties) of the final product as well as facilitating processing such as improved machinability of cookie dough or slicing of processed meats. Therefore functional properties of food proteins are important in food processing and food product formulation. The functional behavior of proteins in food may be influenced by some physicochemical properties of the proteins such as their size, shape, amino acid composition and sequence, net charge, charge distribution, hydrophobicity, hydrophilicity, type of structures, molecular flexibility/rigidity in response to external environment such as pH, temperature, salt concentration or interaction with other food constituents.

Seeds of soybean cultivars in the United States have an average composition of 20% oil, 40% protein, and 15% soluble carbohydrates in dry weights of cotyledons of ungerminated seeds. Hsu, et al. (1973). Traditional varieties of soybeans do not have a high enough protein content to achieve the functional properties required for certain products and applications. Traditionally, this has necessitated the processing of soybeans in order to produce soy products with an increased protein content. Typically, such processing involves at least a defatting step, to remove oils from the soybeans, and a purification step, to remove certain non-proteinaceous components, such as carbohydrates, from the defatted soybeans to provide soy protein concentrates or soy protein isolates.

While soy protein concentrates are less energy- and resource-intensive to obtain than soy protein isolates, the protein content and purity of protein concentrates are substantially lower than those of soy protein isolates. Both of these processes can have undesirable effects on the functional properties of the compositions they produce.

Thus, there is a need not only for soy compositions having high protein content and desirable functional properties, but also for streamlined and inexpensive methods of producing these high-protein soy compositions.

### BRIEF SUMMARY

In one aspect, provided herein are methods of producing a protein-enriched soy composition. In some embodiments, the method comprises providing soybeans having a high protein content; defatting the soybeans by solvent extraction to produce a defatted soybean composition; desolventizing the defatted soybean composition to directly produce a defatted desolventized soybean composition that comprises at least about 65% soy protein on a dry weight basis; contacting the defatted desolventized soybean composition with polar solvent to remove soluble components to produce a concentrated soy composition; and desolventizing the concentrated soy composition to produce a protein-enriched soy protein composition comprising at least about 75% soy proteins on a dry weight basis. In some embodiments, the method further comprises extruding the protein-enriched soy composition to provide a protein-enriched texturized soy composition. In other embodiments, the method further comprises hydrothermally cooking the protein-enriched soy composition and drying the cooked protein-enriched soy composition to provide a protein-enriched re-functionalized soy composition.

In other embodiments, the method comprises providing soybeans having a high protein content; defatting the soybeans by solvent extraction to produce a defatted soybean composition; desolventizing the defatted soybean composition to directly produce a defatted desolventized soybean composition that comprises at least about 65% soy protein on a dry weight basis; contacting the defatted desolventized soybean composition with polar solvent to remove soluble components to produce a concentrated soy composition; desolventizing the concentrated soy composition to produce a protein-enriched soy protein composition comprising at least about 75% soy proteins on a dry weight basis; and extruding the protein-enriched soy composition to provide a protein-enriched texturized soy composition.

In yet another embodiment, the method comprises providing soybeans having a high protein content, defatting the soybeans by solvent extraction to produce a defatted soybean composition, desolventizing the defatted soybean composition to directly produce a defatted desolventized soybean composition that comprise at least about 65% soy protein on a dry weight basis; contacting the defatted desolventized soybean composition with polar solvent to remove soluble components to produce a concentrated soy composition; desolventizing the concentrated soy composition to produce a protein-enriched soy protein composition comprising at least about 75% soy proteins on a dry weight basis; and hydrothermally cooking the protein-enriched soy composition and drying the cooked protein-enriched soy composition to provide a protein-enriched re-functionalized soy composition.

In another aspect, provided herein are protein-enriched soy composition obtainable by or produced according to the methods described herein. In another aspect, provided herein are protein-enriched soy composition that comprise at least about 75% soy protein and a content of low molecular weight soluble dietary fiber is less than or equal to about 40% of the total soluble fiber content.

In yet another aspect, provided herein are protein-enriched texturized soy compositions obtainable by or produced according to the methods described herein. In still another aspect, provided herein is a protein-enriched texturized soy composition that comprises at least about 75% soy protein on a dry weight basis and a content of low molecular weight soluble dietary fiber is less than or equal to about 40% of the total soluble fiber content.

In still yet another aspect, provided herein are protein-enriched re-functionalized soy compositions obtainable by or produced according to the methods described herein. In still another aspect, provided herein is a protein-enriched re-functionalized soy composition that comprises at least about 75% soy protein on a dry weight basis and a content of low molecular weight soluble dietary fiber is less than or equal to about 40% of the total soluble fiber content, wherein the protein-enriched soy composition has a protein dispersibility index of at least 70.

In yet another aspect, provided herein is a food product, a beverage product, a dietary supplement product or other product, comprising protein-enriched soy composition, a protein-enriched texturized soy composition, or a protein-enriched re-functionalized soy composition, in which each composition is as described herein and/or as produced according to the processes described herein.

In some variations of the preceding embodiments and aspects, at least a portion of the soybeans has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, at least a portion of the soybeans has a protein content of at least about 42% soy protein on a dry weight basis. In some variations, at least a portion of the soybeans has a protein content of at least about 45% soy protein on a dry weight basis. In other variations, at least a portion of the soybeans has a protein content of at least about 48% soy protein on a dry weight basis.

### DESCRIPTION OF THE FIGURES

The present application can be understood by reference to the following description taken in conjunction with the accompanying figures.

FIG. 1 shows a plot of protein content (percentage on dry weight basis) in protein-enriched white flakes, as compared to the protein content (percentage on dry weight basis) of the soybeans from which the protein-enriched white flakes are obtained.

FIG. 2 depicts a flowchart for an exemplary method of processing high protein soybeans to produce protein-enriched soy compositions and protein-enriched texturized soy compositions according to the present disclosure.

FIG. 3 depicts a flowchart for an exemplary method of processing high protein soybeans to produce protein-enriched re-functionalized soy compositions according to the present disclosure

FIG. 4 depicts a flowchart for an additional exemplary method of processing high protein soybeans to produce protein-enriched re-functionalized soy compositions according to the present disclosure.

### DETAILED DESCRIPTION

The following description is presented to enable a person of ordinary skill in the art to make and use the various embodiments. Descriptions of specific methods, devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

In some aspects, provided are methods of processing soybeans to provide protein-enriched soy compositions with both a high protein content and desirable protein functionality. The methods described herein use soybeans having a high protein content, and employ extraction and post-processing steps to produce protein-enriched soy compositions that may be substituted for soy protein concentrate and soy protein isolate alike and may have comparable or superior functional properties. In some variations, the protein-enriched soy compositions are protein-enriched soy ingredients that may be further processed and/or incorporated into various food products.

### A. High Protein Soybeans

As described above, provided herein are protein-enriched soy compositions having high protein content that are derived from soybeans having high initial protein contents, as well as methods of processing the same.

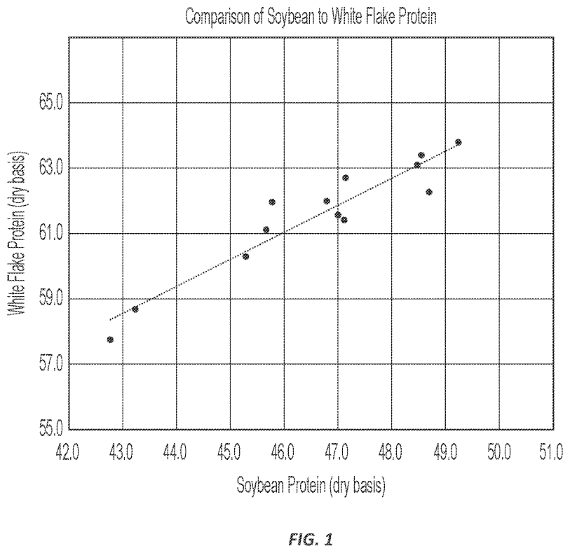

FIG. 1 illustrates an exemplary plot of protein contents of soy white flakes, which are a product of defatting soybeans, relative to the protein contents of soybeans from which the white flakes were produced. As shown in FIG. 1, the protein content in the soy flakes is directly proportional to the protein content initially present in the soybeans, and, thus, the protein content of any single origin soy product is limited to the initial protein content of the source soybeans.

In some embodiments, the soybeans of the present disclosure comprise high protein contents, which enables the production of protein-enriched soy compositions, protein-enriched texturized soy compositions and protein-enriched re-functionalized soy compositions as described for the methods of the present disclosure.

In some embodiments, the protein content of the soybeans having a high protein content may be described as average protein content of the soybeans. In certain embodiments, the protein content of the soybeans having a high protein content may be an average protein content of the soybeans for a given mass of soybeans (e.g., per 1 kilogram mass). In other embodiments, the protein content of the soybeans having a high protein content may be characterized by a distribution of protein contents.

In some embodiments, the soybeans having high protein content may be characterized by protein content as determined by the Kjeldahl method. In other embodiments, the soybeans having high protein content may be characterized by protein content as determined by near-infrared spectroscopy (NIRS).

In still other embodiments, the step of providing soybeans having a high protein content may be achieved by sorting and/or harvesting practices selective for soybeans having high protein content. For example, in some embodiments, the methods provided herein comprise separating a plurality of soybeans according to protein content to provide at least a portion of soybeans having a high protein content from the plurality of soybeans. In some embodiments, the separation of the plurality of soybeans according to protein content is a batch process. In some embodiments, the separation of the plurality of soybeans according to protein content is a continuous process. In certain embodiments, the separation of the plurality of soybeans according to protein content is a high-throughput process. In some embodiments, the separation of the plurality of soybeans according to protein content comprises determining protein content of the plurality of soybeans by NIRS. In some embodiments, the sorting of soybeans as described herein is performed manually. In other embodiments, the sorting of soybeans as described herein is performed mechanically.

In other embodiments, the soybeans used in the methods herein are obtained by harvesting soybeans according to height gradient on the soy plant, e.g., harvesting soybeans growing higher on a given soy plant. In some embodiments, the harvesting soybeans according to the height of the soy plant(s) provides soybeans having a high protein content. In some embodiments, the harvesting of soybeans as described herein is performed manually. In other embodiments, the harvesting of soybeans as described herein is performed mechanically. In some embodiments, the step of providing soybeans having a high protein content comprises (i) separating a plurality of soybeans according to protein content to provide at least a portion of soybeans having a high protein content from the plurality of soybeans; (ii) harvesting soybeans according to the height of the soy plant(s) to provide soybeans having a high protein content; or (iii) a combination of (i) and (ii).

In some variations of the foregoing embodiments, at least a portion of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, at least a portion of the soybeans used has a protein content of at least about 42% soy protein on a dry weight basis. In some variations, at least a portion of the soybeans used has a protein content of at least about 45% soy protein on a dry weight basis. In other variations, at least a portion of the soybeans used has a protein content of at least about 48% soy protein on a dry weight basis.

In other variations of the foregoing embodiments, the soybeans used have an average protein content comprising at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans used have an average protein content of at least about 42% soy protein on a dry weight basis. In some variations, the soybeans used have an average protein content of at least about 45% soy protein on a dry weight basis. In other variations, the soybeans used have an average protein content of at least about 48% soy protein on a dry weight basis.

In yet other variations of the foregoing embodiments, the majority of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the majority of the soybeans used has a protein content of at least about 42% soy protein on a dry weight basis. In some variations, the majority of the soybeans used has a protein content of at least about 45% soy protein on a dry weight basis. In other variations, the majority of the soybeans used has a protein content of at least about 48% soy protein on a dry weight basis.

In some embodiments, the soybeans having a high protein content as used in the methods provided are distinguished from commodity soybeans. Commodity soybeans may have a protein content of less than 40%, or between about 35% and about 40%, on a dry weight basis. The commodity soybeans may also have one or more additional properties: (i) an oil content of between about 15% and about 25% on a dry weight basis; (ii) a moisture content of between about 10% and 15%; (iii) a seed weight of between 10 g and 20 g per 100 seeds; (iv) a lysine content of between 5% and 10%, expressed as a percentage of the 18 primary amino acids; and (v) an essential amino acid content of between 10% and 20%, expressed as a percentage of the 18 primary amino acids. Similarly, the protein-enriched soy compositions, protein-enriched texturized soy compositions, and protein-enriched re-functionalized soy compositions obtained from the soybeans having a high protein content described herein are distinguished from soy protein products obtained from commodity soybeans, such as soy flours, soy white flakes, soy protein concentrates, and soy protein isolates.

The percent composition of a given component in a soybean or sample of soybeans may be described on an “as-is” basis or on a “dry-weight” basis. The percent composition of a given component may be converted between an “as-is” basis and a “dry-weight” basis using the following equation:

$$( \text{protein content} , “ \text{dry-weight} ” basis , \% ) = ( \text{protein content} , “ \text{as-is} ” basis , \% ) / ( ( 100 \% ) - ( \text{moisture content} , \% ) ) \qquad Eq . 1$$

The word “protein” in the above equation may be interchanged with any other soybean component for which conversion between an “as-is” and a “dry-weight” basis is needed, including, e.g., oil. The moisture content of a soybean or soybean product may be determined using any suitable methods or techniques known in in the art. See e.g., Eys, J. E. Van. Manual of Quality Analyses For Soybean Products in The Feed Industry, 2^{nd} ed. U.S. Soybean Export Council.

The soybeans comprising high protein content as employed by the methods of the present disclosure may be further characterized by one or more additional components present in the soybeans, such as oligosaccharide contents. The carbohydrate component of soybeans is comprised of three major oligosaccharides: sucrose, raffinose, and stachyose. Of the three, only sucrose is nutritionally useful and can be fully digested by monogastric animals. Raffinose and stachyose are considered anti-nutritional units because they cannot be digested due to the lack of α-galactosidase activity in the gut of monogastric animals.

In some embodiments, the soybeans having a high protein content may also comprise low raffinose and/or stachyose content. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% raffinose on a dry weight basis. In other embodiments, the soybeans of the present disclosure comprise between about 0% to about 0.13% raffinose on a dry weight basis. In some embodiments, the soybeans of the present disclosure comprise about 0.01%, 0.03%, 1.06%, 0.07%, 0.10%, 0.11% and 0.13% raffinose on a dry weight basis, including all integers and fractions thereof. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% stachyose on a dry weight basis. In other embodiments, the soybeans of the present disclosure comprise about 0.02%, 0.05%, 0.07%, 0.12%, 0.16%, 0.21%, 0.26%, 0.34%, 0.38%, 0.48%, 0.49%, 0.51%, 0.55%, 0.59%, 0.63%, 0.67%, 0.78%, 0.80%, 0.85%, 0.91%, 0.96%, 1.12%, 1.19%, 1.23%, 1.28%, 1.33%, 1.38%, 1.45%, 1.49%, 1.56%, 1.57%, 1.63%, 1.68%, 1.71%, 1.73%, 1.75% stachyose on a dry weight basis, including all integers and fractions thereof.

In some embodiments, the soybeans comprise a combined raffinose and stachyose content of between about 0.02% and 1.75%.

The present invention is not limited to whether the soybeans comprise transgenic polynucleotides or proteins. The soybeans used in the Examples herein are non-transgenic and there are circumstances when using soybeans lacking transgenic traits, genome edits, or any other form of mutation (i.e. a change in a polynucleotide sequence) is necessary and/or beneficial. However, combining the teachings herein with a wide range of transgenic plants, or plants containing genome edits or any other form of mutation to confer new traits or combinations thereof is also envisioned.

In some embodiments of the present disclosure, the soybeans having high protein content as utilized herein may be characterized by any suitable methods known in the art for genetic analysis. In some embodiments, the soybeans as utilized herein may be characterized by genetic analysis as comprising one or more genetic markers associated with high protein content and/or one or more genetic markers associated with low raffinose content and/or one or more genetic markers associated with low stachyose content as described above. In some embodiments, the soybeans as utilized herein may be characterized by genetic analysis as comprising one or more genetic markers associated with high protein content.

### B. Methods of Processing

The present disclosure provides methods of processing soybeans having high protein content (e.g., at least about 42% soy protein on a dry weight basis, at least about 45% soy protein on a dry weight basis, or at least about 48% soy protein on a dry weight basis) to obtain protein-enriched soy compositions, such as protein-enriched soy ingredients, which may be further texturized or re-functionalized, having protein content of at least 75% on a dry weight basis.

### I. Methods for Preparing Protein-Enriched Soy Compositions

In one aspect, provided herein is a method of producing a protein-enriched soy composition that comprises providing soybeans having a high protein content; defatting the soybeans by solvent extraction to produce a defatted soybean composition; desolventizing the defatted soybean composition to directly produce a defatted desolventized soybean composition that comprises at least about 60%; contacting the defatted desolventized soybean composition with a polar solvent to remove soluble components to produce a concentrated soy composition; and desolventizing the concentrated soy composition to produce a protein-enriched soy protein composition comprising at least about 75% soy proteins on a dry weight basis. In some variations of the foregoing aspect, the soybeans having a high protein content comprise at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans comprise at least about 42% soy protein on a dry weight basis. In some variations, the soybeans comprise at least about 45% soy protein on a dry weight basis. In other variations, the soybeans comprise at least about 48% soy protein on a dry weight basis.

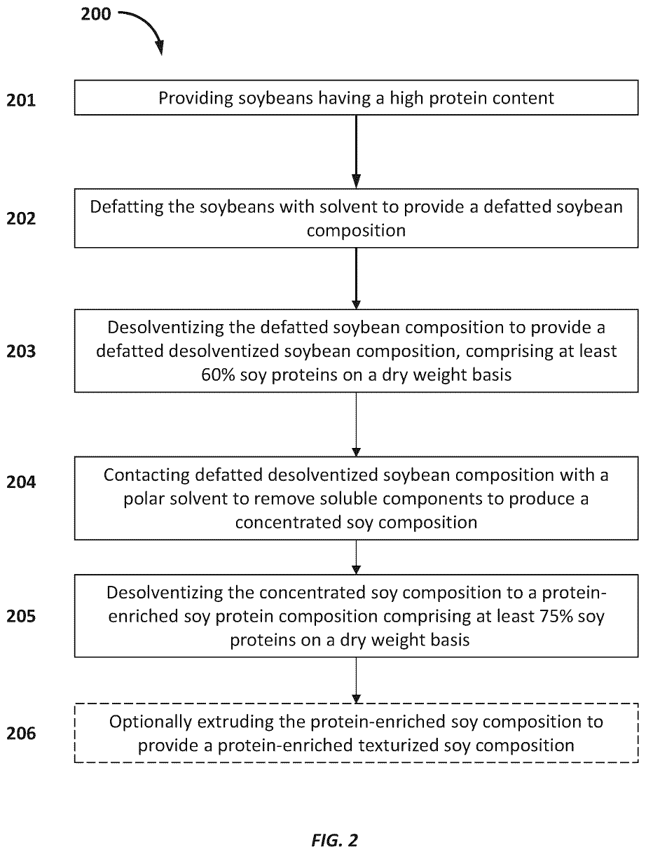

With reference to FIG. 2, process 200 is an exemplary process to prepare a protein-enriched soy composition. In step 201, soybeans having a high protein content are provided. In some variations, the soybeans may have a protein content as described in the preceding paragraph. In one variation, the soybeans comprise at least about 42% soy protein on a dry weight basis. In another variation, the soybeans comprise at least about 45% soy protein on a dry weight basis. In yet another variation, the soybeans comprise at least about 48% soy protein on a dry weight basis.

With reference again to FIG. 2, in step 202, the soybeans are defatted to provide a soybean seed composition. In step 203, the soybean seed composition is desolventized to provide a defatted desolventized soybean composition, which comprises at least about 60% soy protein on a dry weight basis. In step 204, the defatted desolventized soybean composition is contacted with a polar solvent, such as ethanol and/or water, in order to remove soluble components, e.g., oligosaccharides and soluble dietary fiber, to produce a concentrated soy composition. The concentrated soy composition obtained from step 205 is then desolventized to produce a protein-enriched soy composition, which has at least about 75% soy proteins on a dry weight basis. The protein-enriched soy composition can be optionally further treated, for example, to modify the functional properties of the soy composition. For example, in step 206, the protein-enriched soy composition is extruded to provide protein-enriched texturized soy composition.

It should be understood that, in other variations, process 200 may include additional processing steps. In yet other variations, certain steps in process 200 may be omitted. In some embodiments, step 201 further comprises cleaning the soybeans. In some embodiments, step 201 further comprises tempering the soybeans. Any suitable methods of tempering soybeans known in the art may be employed. In some embodiments, step 201 further comprises cracking the soybeans.

In some embodiments, step 201 further comprises dehulling the soybeans. Any suitable techniques known in the art to remove the hulls from the soybeans may be employed. For example, in some variations, the soybeans are subjected to abrasive force in order to remove the hulls. In certain variations, dehulling may be carried out with an attrition mill or an impeller, or mechanical equivalent. In one variation, the dehulling step does not utilize wet removal methods, such as blanching, alkaline and/or aqueous dissolution. In certain embodiments, the soybeans undergo thermal treatment prior to hull removal. In some variations, such thermal treatment is a dry dehulling process, which is distinguished from a wet dehulling process that may involve, for example, blanching. In certain embodiments, the soybeans subjected to the thermal treatment may be characterized by their moisture content. In some variations, the treated soybeans obtained from the thermal treatment have a moisture content of less than or equal to about 20% w/w, less than or equal to about 17% w/w, less than or equal to about 15% w/w, less than or equal to about 12% w/w, less than or equal to about 10% w/w, or less than or equal to about 8% w/w, without further drying. In other variations, the treated soybeans obtained from the thermal treatment have a moisture content of between about 5% w/w and about 20% w/w, between about 5% w/w and about 17% w/w, between about 5% w/w and about 15% w/w, between about 5% w/w and about 12% w/w, between about 5% w/w and about 10% w/w, between about 5% w/w and about 8% w/w, between about 8% w/w and about 20% w/w, between about 8% w/w and about 17% w/w, between about 8% w/w and about 15% w/w, between about 8% w/w and about 12% w/w, between about 8% w/w and about 10% w/w, between about 10% w/w and about 20% w/w, between 10% w/w and about 17% w/w, between about 10% w/w and about 15% w/w, between about 10% w/w and about 12% w/w, between about 12% w/w and about 20% w/w, between about 12% w/w and about 17% w/w, between about 12% w/w and about 15% w/w, between about 15% w/w and about 20% w/w, between about 15% w/w and about 17% w/w, or between about 17% w/w and about 20% w/w, without further drying. In yet other variations, the treated soybeans obtained from the thermal treatment may be dried in order to control the moisture content prior to further processing to remove oil and obtain a defatted soybean.

In some variations, removing the hulls from the soybeans results in a mixture comprising dehulled soybeans and detached hulls. As such, the method may further comprise separating the detached hulls from the dehulled soybeans. In some embodiments, the method further comprises separating the dehulled soybeans from the detached hulls by hand separation, by sieving or screening, or aerodynamic separation (i.e., weight classification by aspiration).

In some embodiments, step 201 further comprises flaking the soybeans. In some such embodiments, flaking may be achieved by rolling the beans between two smooth cylindrical rollers. In some such embodiments, the soybeans may be pre-treated with heat and steam to facilitate flaking. In other embodiments, step 201 further comprises grinding the soybeans. Any suitable methods of grinding known in the art may be employed. For example, grinding can be performed using equipment such as hammer mill, FitzMill or Quadromill.

In some embodiments, the defatting process of step 202 involves combining the soybeans with a solvent to provide an extraction mixture. In some embodiments, the solvent used to defat the beans in step 202 may be a nonpolar solvent. In some embodiments, the solvent is an alkane solvent. In some such embodiments, the solvent may be hexane. In some embodiments, the solvent is water. In some embodiments, the solvent is not an alcohol. In some embodiments, the solvent may contain one or more co-solvents.

In some such embodiments, combining the soybeans and the solvent comprises combining the soybeans and the solvent in an extractor to provide an extraction mixture. In certain embodiments, the step of combining comprises mixing, agitating, or stirring the extraction mixture in an extractor. In some embodiments, combining the soybeans and the solvent to provide an extraction mixture comprises heating the soybeans and the solvent to provide an extraction mixture. In still other embodiments, the method further comprises heating the extraction mixture. It should be noted that the foregoing methods may include variations of other parameters that may be part of the combining step including, for example, the residence time of the extraction mixture in the extractor, extractor temperature and pressure, extractor chain speed, particle size distribution of the soybeans, the ratio of soybeans to the solvent, and feed rates of the soybeans and solvent into the extractor.

In some embodiments, the extraction mixture is separated into a miscella and a defatted soybean composition. The miscella primarily contains the liquid fraction of the extraction mixture (oil, solvent, and any soluble compounds), whereas the defatted soybean composition largely is composed of the residual insoluble solid material, or meal, that remains from the soybeans. The step of separating the extraction mixture into a miscella and a defatted soybean composition may include any suitable methods known in the art for the solid-liquid separations. In certain embodiments, the extraction mixture is separated by filtration. In other embodiments, the extraction mixture is separated by decanting.

As described above, the defatted soybean composition largely is composed of the residual insoluble solid material, that remains from the soybeans following extraction with the solvent of step 202 and solid-liquid separation to remove the miscella. The resulting defatted soybean composition comprising less than about 3% fat as described herein may further comprise any of number of components, such as carbohydrates, sugars, proteins, fiber, ash, or other components, that are originally present in the soybeans. For example, in some embodiments the defatted soybean composition comprises at least about 60% protein by dry weight. In certain embodiments, the defatted soybean composition comprises about 60-65% protein by dry weight. In other embodiments wherein the defatted soybean composition comprises total dietary fiber, the soybean composition comprises at most about 20% total dietary fiber by dry weight.

It should be recognized that, due to the nature of the extraction method described herein comprising combining soybeans with a solvent, the defatted soybean composition may contain residual levels of the solvent. For example, the defatted soybean composition may contain residual levels of hexane and any co-solvents used, even after separation of the miscella from the defatted soybean composition. Thus, in some embodiments, the defatted soybean composition comprises solvent. In certain embodiments, the defatted soybean composition has a solvent concentration of less than about 100,000 ppm. In other embodiments wherein the solvent combined with the soybeans comprises hexane, the defatted composition comprises hexane. In certain embodiments wherein the defatted soybean composition comprises hexane, the defatted soybean composition has a hexane concentration of less than about 100,000 ppm.

Thus, the method of the present disclosure further includes the desolventization process of step 203. In some embodiments, the desolventization process of step 203 comprises a dry heating or toasting step to de-solventize, that is, to reduce the level of solvent in, the defatted soybean composition. Therefore, in some embodiments, the method further comprises toasting the defatted soybean composition to provide a toasted defatted soybean composition. In other embodiments, the desolventization process of step 203 comprises a flash desolventization step, wherein the defatted soybean composition is contacted with superheated solvent vapors in order to reduce the level of solvent in the defatted soybean composition. In some embodiments, wherein the solvent is hexane, the flash desolventization step comprises contacting the defatted soybean composition with hexane vapors. In some such embodiments, the hexane vapors are heated. In some wherein the desolventization process of step 203 comprises a flash desolventization step, the flash desolventization step further comprises contacting the defatted soybean composition with steam to further reduce the level of solvent in the defatted soybean composition. In some embodiments, the flash desolventization step is performed under vacuum.

In some embodiments, following desolventization of the defatted soybean composition, the defatted soybean composition comprises a solvent and has a solvent concentration of less than or equal to about 5,000 ppm. In certain embodiments, the desolventized defatted soybean composition has a solvent concentration between about 0 ppm and about 5,000 ppm, between about 0 ppm and about 1,000 ppm, between about 1,000 ppm and about 3,000 ppm, or between about 3,000 ppm and about 5,000 ppm. In still yet other embodiments wherein the solvent is hexane, the desolventized defatted soybean composition comprises hexane and has a hexane concentration of less than or equal to about 5,000 ppm. In certain embodiments wherein the solvent is hexane, the desolventized defatted soybean composition comprises hexane and has a hexane concentration between about 0 ppm and about 5,000 ppm, between about 0 ppm and about 1,000 ppm, between about 1,000 ppm and about 3,000 ppm, or between about 3,000 ppm and about 5,000 ppm.

In some embodiments, the defatted desolventized soybean composition described above is the defatted desolventized soybean composition provided by step 203. In some embodiments, the defatted desolventized soybean composition comprises soy protein flour, soy protein yellow flakes, or soy protein white flakes. In some embodiments, the defatted desolventized soybean composition provided by step 203 comprises at least about 55% protein on a dry weight basis. In some such embodiments, the defatted desolventized soybean composition comprises at least about 60% protein on a dry weight basis. In some such embodiments, the defatted desolventized soybean composition comprises at least about 65% protein on a dry weight basis.

It should be recognized that the methods of the present disclosure may directly produce a defatted desolventized soybean composition from the defatted soybean composition in the process of desolventization. As used herein, to “directly produce” a defatted desolventized soybean composition means to do so without additional steps and/or without the addition/removal of material (such as soluble carbohydrates), and/or without changing the environment, in order to increase the protein content of the defatted desolventized soybean composition. An example of a production process that is not direct is one using an additional alcohol and/or water extraction step on the defatted desolventized soybean composition to arrive at a protein-enriched soy product, e.g. a soy protein concentrate. Another example of a production process that is not direct is one using ultrafiltration of slurried defatted desolventized soybean composition to arrive at a protein-enriched soy product, e.g. a soy protein concentrate.

Following desolventization in step 203 to produce a defatted desolventized soybean composition, the defatted desolventized soybean composition is contacted with a polar solvent, such as alcohol or water, in step 204 to remove components which are soluble in the polar solvent. The removal of such soluble components produces a concentrated soy composition. In some embodiments, the polar solvent comprises alcohol, or water, or a mixture thereof. In certain embodiments, the alcohol is ethanol. In other embodiments, the polar solvent does not contain alcohol. In other embodiments the polar solvent is water. In some embodiments, the polar solvent comprises an acid. In some embodiments, the polar solvent is an aqueous acid solution.

The soluble components extracted from the defatted desolventized soybean composition by the polar solvent in step 204 may include but are not limited to mono-, di- or oligosaccharides, soluble fiber, and/or other soluble carbohydrates. In some embodiments, the step of contacting the defatted desolventized soybean composition with a polar solvent removes one or more oligosaccharides. Oligosaccharides removed by this process may include but are not limited to raffinose, stachyose, fructose, glucose, sucrose, maltose, and lactose. In some embodiments, the total sugar content of the resulting concentrated soy composition and other downstream products, may be reduced after step 204. In other embodiments, the step of contacting the defatted desolventized soybean composition with a polar solvent removes soluble dietary fiber. In certain embodiments, soluble dietary fiber removed by this process may include low molecular weight soluble dietary fiber (LMWSDF) and/or high molecular weight soluble dietary fiber (HMWSDF). The categories of dietary fiber—including soluble, insoluble, resistant starch, high molecular weight (insoluble and soluble) and low molecular weight—are defined as provided in the CODEX Alimentarius (2008). In some embodiments, any of the total dietary fiber, total soluble dietary fiber, soluble high molecular weight dietary fiber and soluble low molecular eight dietary fiber of the resulting concentrated soy composition and protein-enriched soy compositions produced therefrom, may be reduced after step 204.

The concentrated soy composition produced by the removal for soluble components from the defatted desolventized soybean composition may contain substantial amounts of polar solvent, even after the bulk of the concentrated soy composition has been separated from the majority of polar solvent, for example, by filtration or decanting. The method of the present disclosure further includes the desolventization process of step 205 to provide a protein-enriched soy composition. In some embodiments, the desolventization process of step 205 comprises a dry heating or toasting step to de-solventize, that is, to reduce the level of polar solvent in, the concentrated soy composition. Therefore, in some embodiments, the method comprises toasting the concentrated soy composition to provide a protein-enriched soy composition.

In some embodiments, the protein-enriched soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% protein on a dry weight basis. In some embodiments, the protein-enriched soy composition comprises at least about 70% protein on a dry weight basis. In some embodiments, the protein-enriched soy composition comprises at least about 75% protein on a dry weight basis. In other embodiments, the protein-enriched soy composition comprises at least about 80% protein on a dry weight basis.

In some embodiments, the protein-enriched soy composition provided by step 205 has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof, as compared to a soy protein concentrate produced from commodity soybeans. In some embodiments, the protein-enriched soy composition has any combinations of the above. In some embodiments, the protein-enriched soy composition has all of the above.

In some embodiments, the protein-enriched soy composition has a reduced quantity of lipoxygenase enzyme as compared as compared to a soy protein concentrate produced from commodity soybeans, as determined by gel electrophoresis, such as SDS-PAGE.

The process 200 as shown in FIG. 2 may further optionally comprise additional treatment of the protein-enriched soy composition. For example, in some embodiments, the protein-enriched soy composition is further processed to produce protein-enriched textured soy composition. In some embodiments, as in step 206, texturization is accomplished using an extrusion process, such as with a twin-screw extruder. Accordingly, in some embodiments, the method optionally further comprises extruding the protein-enriched soy composition to provide a protein-enriched texturized soy composition.

In some embodiments, the protein-enriched texturized soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% soy protein on a dry weight basis. In some embodiments, the protein-enriched texturized soy composition comprises at least about 70% soy protein on a dry weight basis. In some embodiments, the protein-enriched texturized soy composition comprises at least about 75% soy protein on a dry weight basis. In other embodiments, the protein-enriched texturized soy composition comprises at least about 80% soy protein on a dry weight basis.

In some embodiments, the protein-enriched texturized soy composition provided by step 205 has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof, as compared to a soy protein concentrate produced from commodity soybeans. In some embodiments, the protein-enriched texturized soy composition has any combinations of the above. In some embodiments, the protein-enriched texturized soy composition has all of the above.

In some embodiments, the protein-enriched texturized soy composition has a reduced quantity of lipoxygenase enzyme as compared as compared to a soy protein concentrate produced from commodity soybeans, as determined by gel electrophoresis, such as SDS-PAGE.

In some embodiments, the process 200 as shown in FIG. 2 uses less water per ton of protein-enriched soy protein composition than a composition with the same protein content prepared using commodity soybeans.

In some embodiments, the process 200 as shown in FIG. 2 uses less electricity per ton of protein-enriched soy protein composition than a composition with the same protein content prepared using commodity soybeans.

In some embodiments, the process 200 as shown in FIG. 2 results in the release of less CO₂ into the atmosphere per ton of protein-enriched soy protein composition than a composition with the same protein content prepared using commodity soybeans. In some embodiments, step 201 of process 200 further comprises cultivating soybeans, harvesting the soybeans, and transporting the soybeans from a harvesting location to a processing location, and process 200 results in the release of less CO₂ into the atmosphere per ton of protein-enriched soy protein composition than a composition with the same protein content prepared using commodity soybeans.

### II. Methods for Preparing Protein-Enriched Re-Functionalized Soy Compositions

As described herein, purification processes to extract soy protein from soy beans, and further concentrate and/or isolate it by removing other non-proteinaceous components may encompass alcohol extraction or aqueous (acid) extraction. The extraction solvents and conditions can have undesirable effects on the functional properties, including by denaturing and/or aggregating the proteins that have been separated. Denatured and/or aggregated proteins may exhibit reduced functionality across a range of physicochemical properties, including but not limited to solubility or dispersibility, viscosity, emulsion strength, gelling capacity or strength, water and/or oil binding capacity, or foaming properties. However, some degree of functionality may be restored to the protein-enriched soy compositions obtained according the methods described herein, through additional treatments, such as with pH adjustment, heat, pressurization, and/or the introduction of additives.

In another aspect, provided herein is a method of producing a protein-enriched re-functionalized soy composition, the method comprising providing soybeans having a high protein content, defatting the soybeans by solvent extraction to produce a defatted soybean composition, desolventizing the defatted soybean composition to directly produce a defatted desolventized soybean composition that comprises at least about 60%, contacting the defatted desolventized soybean composition with a polar solvent to remove soluble components to produce a concentrated soy composition; desolventizing the concentrated soy composition to produce a protein-enriched soy protein composition comprising at least about 75% soy proteins on a dry weight basis; and hydrothermally cooking the protein-enriched soy composition and drying the cooked protein-enriched soy composition to provide a protein-enriched re-functionalized soy composition. In some variations of the foregoing aspect, the soybeans having a high protein content comprise at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans comprise at least about 42% soy protein on a dry weight basis. In some variations, the soybeans comprise at least about 45% soy protein on a dry weight basis. In other variations, the soybeans comprise at least about 48% soy protein on a dry weight basis.

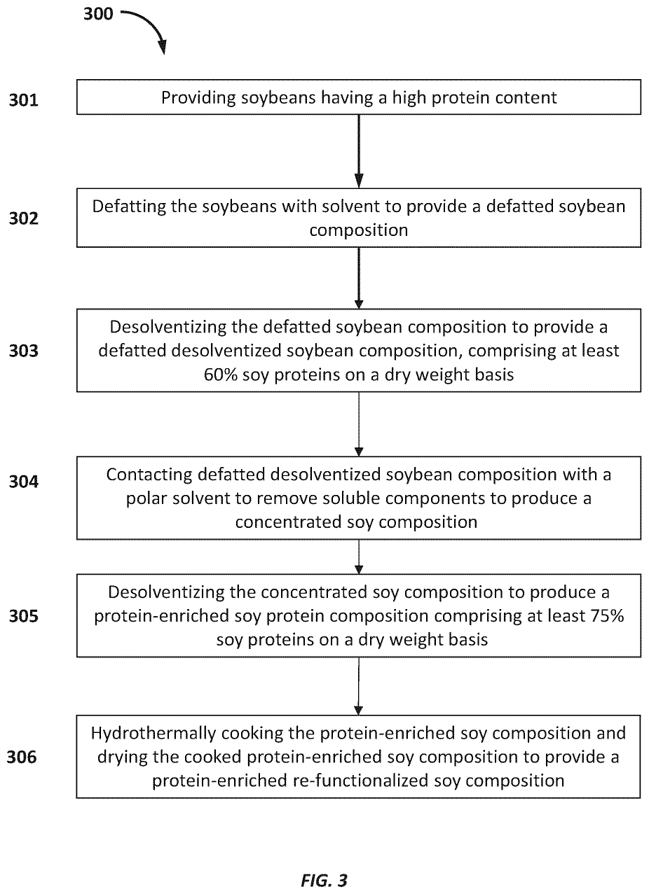

With reference to FIG. 3, process 300 is an exemplary process to prepare a protein-enriched re-functionalized soy composition. In step 301, soybeans having a high protein content are provided. In some variations, the soybeans may have a protein content as described in the preceding paragraph. In one variation, the soybeans comprise at least about 42% soy protein on a dry weight basis. In another variation, the soybeans comprise at least about 45% soy protein on a dry weight basis. In yet another variation, the soybeans comprise at least about 48% soy protein on a dry weight basis.

With reference again to FIG. 3, in step 302, the soybeans are defatted to provide a soybean seed composition. In step 303, the soybean seed composition is desolventized to provide a defatted desolventized soybean composition, which comprises at least about 60% soy protein on a dry weight basis. In step 304, the defatted desolventized soybean composition is contacted with a polar solvent, such as ethanol and/or water, in order to remove soluble components, e.g., oligosaccharides and soluble dietary fiber, to produce a concentrated soy composition. The concentrated soy composition obtained from step 305 is then desolventized to produce a protein-enriched soy composition, which has at least about 75% soy proteins on a dry weight basis. In step 306, the protein-enriched soy composition is further hydrothermally cooked and dried to provide a protein-enriched re-functionalized soy composition.

It should be understood that, in other variations, process 300 may include additional processing steps. In yet other variations, certain steps in process 300 may be omitted.

It should be further understood that any single embodiment, or any combination of embodiments as described for any of the steps 201 through 205 of process 200 may apply to steps 301 through 305 of process 300 for producing a protein-enriched re-functionalized soy composition.

In step 306, the protein-enriched soy composition is further hydrothermally cooked and the resulting cooked protein-enriched soy composition is dried to provide a protein-enriched re-functionalized soy composition. In some embodiments, the method comprises hydrothermally cooking the protein-enriched soy composition and drying the cooked protein-enriched soy composition to provide a protein-enriched re-functionalized soy composition.

Any suitable techniques known in the art for hydrothermal cooking, steam-jet cooking, or jet-cooking may be employed. For example, the material to be cooked may be subjected to high pressures and temperatures to modify the physicochemical properties of the material. In some embodiments, hydrothermally cooking the protein-enriched soy composition comprises preparing a slurry of the protein-enriched soy composition and injecting steam into the slurried soy composition. The steam injection may be conducted at a suitable temperature, pressure and duration to achieve the desired final characteristics of the protein-enriched re-functionalized soy composition. The temperature, pressure and duration may be adjusted in concert with one another—for example, higher steam injection temperatures may be coupled with shorter duration injection periods. It should be recognized, however, that the conditions for steam injection may be also varied independently of one another. In some embodiments, the method comprises hydrothermally cooking the protein-enriched soy composition at a temperature of between about 50° C. and about 250° C., between about 50° C. and about 200° C., between about 50° C. and about 150° C., between about 50° C. and about 100° C., between about 100° C. and about 250° C., between about 150° C. and about 250° C., between about 200° C. and about 250° C., between about 150° C. and about 250° C., between about 150° C. and about 200° C., or between about 200° C. and about 250° C.

With reference again to step 306, following the hydrothermal cooking, the cooked protein-enriched soy composition is dried. In some embodiments, the drying of the cooked protein-enriched soy composition comprises a dry heating or toasting step. In some embodiments, the cooked protein-enriched soy composition can be dried using non-thermal drying techniques, including but not limited to spray-drying or lyophilization. In some embodiments, the drying of the cooked protein-enriched soy composition comprises a spray-drying step. In other embodiments, the drying of the cooked protein-enriched soy composition comprises a lyophilization step.

In yet another aspect, provided herein is a method for producing a protein-enriched re-functionalized soy composition, the method comprising providing soybeans having a high protein content; defatting the soybeans by solvent extraction to produce a defatted soybean composition, desolventizing the defatted soybean composition to directly produce a defatted desolventized soybean composition that comprises at least about 60%, contacting the defatted desolventized soybean composition with a polar solvent to remove soluble components to produce a concentrated soy composition; desolventizing the concentrated soy composition to produce a protein-enriched soy protein composition comprising at least about 75% soy proteins on a dry weight basis; and hydrating, optionally with pH adjustment, and spray-drying the protein-enriched soy protein composition to provide a protein-enriched re-functionalized soy composition. In some variations of the foregoing aspect, the soybeans having a high protein content comprise at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans comprise at least about 42% soy protein on a dry weight basis. In some variations, the soybeans comprise at least about 45% soy protein on a dry weight basis. In other variations, the soybeans comprise at least about 48% soy protein on a dry weight basis.

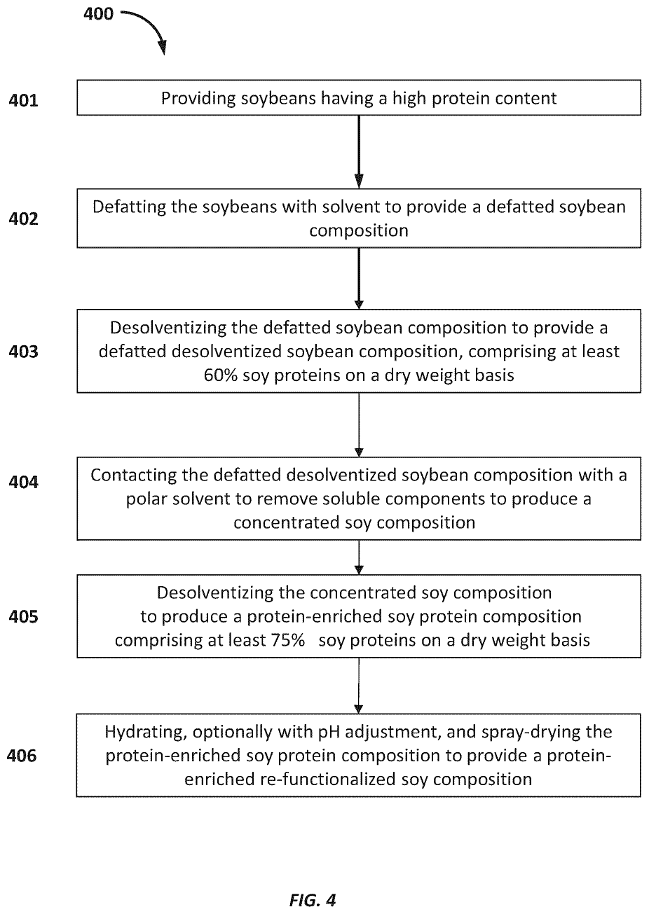

With reference to FIG. 4, process 400 is an exemplary process to prepare a protein-enriched re-functionalized soy composition. In step 401, soybeans having a high protein content are provided. In some variations, the soybeans may have a protein content as described in the preceding paragraph. In one variation, the soybeans comprise at least about 42% soy protein on a dry weight basis. In another variation, the soybeans comprise at least about 45% soy protein on a dry weight basis. In yet another variation, the soybeans comprise at least about 48% soy protein on a dry weight basis.

With reference again to FIG. 4, in step 402, the soybeans are defatted to provide a soybean seed composition. In step 403, the soybean seed composition is desolventized to provide a defatted desolventized soybean composition, which comprises at least about 60% soy protein on a dry weight basis. In step 404, the defatted desolventized soybean composition is contacted with a polar solvent, such as ethanol or water, in order to remove soluble components, e.g., oligosaccharides and soluble dietary fiber, to produce a concentrated soy composition. The concentrated soy composition obtained from step 405 is then desolventized to produce a protein-enriched soy composition, which has at least about 75% soy proteins on a dry weight basis. In step 406, the protein-enriched soy composition is further hydrated, optionally with additional pH adjustment, and spray-dried to provide a protein-enriched re-functionalized soy composition.

It should be understood that, in other variations, process 400 may include additional processing steps. In yet other variations, certain steps in process 400 may be omitted.

It should be further understood that any single embodiment, or any combination of embodiments as described for any of the steps 201 through 205 of process 200 or steps 301 through 305 of process 300 may apply to steps 401 through 405 of process 400 for producing a protein-enriched re-functionalized soy composition.

With reference to FIG. 4 again, in step 406, the protein-enriched soy composition is further hydrated and optionally adjusted for pH. In some embodiments, the step of hydrating comprises adding water to the protein-enriched soy composition to provide a hydrated soy composition. In some embodiments, the step of hydrating comprises adding water and acid to the protein-enriched soy composition to provide a hydrated soy composition. The protein-enriched soy composition and water—and pH modifying agent if applicable—may be further optionally subjected to mixing, agitating, or stirring to facilitate hydration. Following hydration, the hydrated soy composition is spray-dried to provide protein-enriched re-functionalized soy composition.

In some embodiments, the protein-enriched soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% soy protein on a dry weight basis. In some embodiments, the protein-enriched soy composition comprises at least about 70% soy protein on a dry weight basis. In some embodiments, the protein-enriched soy composition comprises at least about 75% soy protein on a dry weight basis. In other embodiments, the protein-enriched soy composition comprises at least about 80% soy protein on a dry weight basis.

In some embodiments, the protein-enriched re-functionalized soy composition provided by step 306 or step 406 has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof, as compared to a soy protein concentrate produced from commodity soybeans. In some embodiments, the protein-enriched re-functionalized soy composition has any combinations of the above. In some embodiments, the protein-enriched re-functionalized soy composition has all of the above.

In some embodiments, the protein-enriched re-functionalized soy composition has a reduced quantity of lipoxygenase enzyme as compared as compared to a soy protein concentrate produced from commodity soybeans, as determined by SDS-PAGE.

### C. Compositions

In addition to the methods of processing soybeans having high protein content (e.g., at least about 42% soy protein on a dry weight basis, at least about 45% soy protein on a dry weight basis, or at least about 48% soy protein on a dry weight basis) provided herein, the present disclosure also provides protein-enriched soy compositions, such as protein-enriched soy compositions, protein-enriched texturized soy compositions, and protein-enriched re-functionalized soy compositions.

As detailed above, the protein-enriched soy compositions, protein-enriched texturized soy compositions, and protein-enriched re-functionalized soy compositions are obtained from soybeans having high protein content as utilized herein. The soybeans may also be characterized as having other favorable characteristics, such as low raffinose and/or stachyose content. As detailed above, the soybeans having high protein content and/or other favorable characteristics may be characterized by any suitable methods known in the art as having one or more genetic markers associated with the high protein content and/or other favorable characteristics present in the soybeans.

Although the compositions of the protein-enriched soy compositions, protein-enriched texturized soy compositions, and protein-enriched re-functionalized soy compositions will differ from the source soybeans as a result of the processing methods described herein, the resulting protein-enriched soy compositions, protein-enriched texturized soy compositions, and protein-enriched re-functionalized soy compositions may contain detectable remnants of genetic material associated with the source soybeans having high protein content. In certain embodiments, the soy products provided herein may contain genetic material tied to particular genetic markers (e.g., biomarkers associated with high protein content and/or other favorable characteristics) which were present in the source soybeans, and may be similarly characterized by genetic analysis to identify the same markers. In some embodiments, the protein-enriched soy compositions provided herein and obtained from soybeans as utilized herein may be characterized by genetic analysis. In some embodiments, any suitable techniques known in the art may be used to characterize the protein-enriched soy compositions, protein-enriched texturized soy compositions, and protein-enriched re-functionalized soy compositions provided herein as comprising one or more genetic markers associated with high protein content in soybeans. In other embodiments, any suitable techniques known in the art may be used to characterize the protein-enriched soy compositions, protein-enriched texturized soy compositions, and protein-enriched re-functionalized soy compositions provided herein as comprising one or more genetic markers associated with low raffinose content and/or one or more genetic markers associated with low stachyose content as described above. In some embodiments, the soybeans as utilized herein may be characterized by genetic analysis as comprising one or more genetic markers associated with high protein content.

### I. Protein-Enriched Soy Compositions

In one aspect, provided herein is a protein-enriched soy composition. In another aspect, provided herein are protein-enriched soy composition comprising at least about 70% soy protein on a dry weight basis.

In another aspect, provided is protein-enriched soy composition, comprising at least about 75% soy proteins on a dry weight basis, and a content of low molecular weight soluble dietary fiber is less than or equal to about 40% of the total soluble fiber content. In yet another aspect, provided herein is a protein-enriched soy composition obtainable or produced by the methods according to the present disclosure. The compositions and properties of the protein-enriched soy compositions are described in further detail below.

### Soy Protein Content

The protein-enriched soy composition provided herein has a high soy protein content, including relative to the soy protein content of the soybeans from which the protein-enriched soy composition was obtained.

In some embodiments, the protein-enriched soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% soy protein on a dry weight basis. In some embodiments, the protein-enriched soy composition comprises at least about 70% soy protein on a dry weight basis. In some embodiments, the protein-enriched soy composition comprises at least about 75% soy protein on a dry weight basis. In other embodiments, the protein-enriched soy composition comprises at least about 80% protein on a dry weight basis. In some embodiments, the protein-enriched soy composition comprises between about 70% and about 85% soy protein on a dry weight basis.

In certain embodiments, the protein-enriched soy composition has at least about 1.4 times, at least about 1.5 times, at least about 1.7 times, or at least about 2 times more soy protein per unit weight than the soybeans from which the protein-enriched soy composition was obtained. In some embodiments, the protein-enriched soy composition comprises between about 1.4 and about 1.7 times more soy protein than the soybeans from which the protein-enriched soy composition was obtained.

### Carbohydrate Content

The present disclosure provides for methods of obtaining protein-enriched soy compositions, involving treatment of defatted desolventized soybean compositions with polar solvents to remove soluble components, such as oligosaccharides, soluble fiber, and/or other soluble carbohydrates. As such, the low carbohydrate content of the protein-enriched soy composition as provided herein reflects the methods through which the protein-enriched soy composition can be obtained.

It should also be recognized that the protein-enriched soy compositions of the present disclosure may comprise a particular profile of carbohydrates, including oligosaccharide content and soluble or insoluble fiber ratios, reflective of the methods of the present disclosure. The carbohydrate and/or fiber composition of the protein-enriched soy compositions may distinguish the protein-enriched soy compositions from other commercially available soy products prepared from blends of soy flours, soy protein concentrates, and/or soy protein isolates. It should be further recognized that the carbohydrate and/or fiber profiles of the protein-enriched soy compositions provided herein may contribute to their functional properties. In some embodiments, the protein-enriched soy composition is unblended, and is substantially free of soy protein concentrate obtained from commodity soybeans or soy protein isolate obtained from commodity soybeans.

In some embodiments, the protein-enriched soy composition may be characterized by its total sugar content. In other embodiments, the protein-enriched soy composition may be characterized by its oligosaccharide content. In certain embodiments, the protein-enriched soy composition may be characterized by the content of one or more individual oligosaccharides, including but not limited to raffinose, stachyose, fructose, glucose, sucrose, maltose, and lactose. In some such embodiments, the protein-enriched soy composition comprises less than or equal to about 2%, less than or equal to about 1%, less than or equal to about 0.7% or less than or equal to about 0.5% total sugars on a dry weight basis. In some such embodiments, the protein-enriched soy composition comprises less than or equal to about 2%, less than or equal to about 1%, less than or equal to about 0.7% or less than or equal to about 0.5% oligosaccharides on a dry weight basis.

In some embodiments, the protein-enriched soy composition may be characterized by the content of certain oligosaccharides, including but not limited to sucrose, stachyose, and raffinose, which contribute to the total sugar content. In some embodiments, the protein-enriched soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% of any individual oligosaccharide on a dry weight basis. In some embodiments, the protein-enriched soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% sucrose on a dry weight basis. In some embodiments, the protein-enriched soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% stachyose on a dry weight basis. In some embodiments, the protein-enriched soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% raffinose on a dry weight basis.

In some embodiments, the protein-enriched soy composition provided herein may be characterized by the total dietary fiber content or any other subcategories of dietary fiber. Some subcategories of dietary fiber include soluble dietary fiber (SDF), insoluble dietary fiber (IDF), resistant starch (RF), high molecular weight dietary fiber which further encompasses high molecular weight insoluble dietary fiber (HMWIDF) and high molecular weight soluble dietary fiber (HMWSDF), and low molecular weight soluble dietary fiber (LMWSDF). These subcategories are defined as provided in the CODEX Alimentarius (2008).

In some embodiments, the protein-enriched soy composition provided herein has a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched soy composition provided herein has a total dietary fiber of less than or equal to about 25%.

In some embodiments, the protein-enriched soy composition provided herein has less than or equal to about 27%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% insoluble dietary fiber on a dry weight basis. In some embodiments, the protein-enriched soy composition provided herein has an insoluble dietary fiber content of less than or equal to about 25% on a dry weight basis.

In some embodiments, the protein-enriched soy composition of the present disclosure has less than or equal to about 5%, less than or equal to about 4.5%, less than or equal to about 4%, less than or equal to about 3.5%, or less than or equal to about 3% soluble dietary fiber on a dry weight basis. In certain embodiments, the protein-enriched soy composition of the present disclosure has less than or equal to about 4% soluble dietary fiber on a dry weight basis. In certain other embodiments, the protein-enriched soy composition of the present disclosure has less than or equal to about 3% soluble dietary fiber on a dry weight basis.

In some embodiments, the protein-enriched soy composition has a content of high molecular weight soluble dietary fiber of less than or equal to about 3%, less than or equal to about 2.7%, less than or equal to about 2.5%, less than or equal to about 2.2%, less than or equal to about 2%, or less than or equal to about 1.7% on a dry weight basis. In certain embodiments, the protein-enriched soy composition has a content of high molecular weight soluble dietary fiber of less than or equal to about 2.5%.

In some embodiments, the protein-enriched soy composition has a content of low molecular weight soluble dietary fiber of less than or equal to about 2%, less than or equal to about 1.7%, less than or equal to about 1.5%, less than or equal to about 1.2%, less than or equal to about 1%, or less than or equal to about 0.9% on a dry weight basis. In certain embodiments, the protein-enriched soy composition has a content of low molecular weight soluble dietary fiber of less than or equal to about 1.5%.

In still other embodiments, the protein-enriched soy composition may be characterized by the ratio of high molecular weight soluble dietary fiber to the low molecular weight soluble dietary fiber, or the percentages of high molecular weight and low molecular weight soluble dietary fiber out of the total soluble dietary fiber present. For example, in some embodiments, the protein-enriched soy composition has a ratio of high molecular weight soluble dietary fiber to the low molecular weight soluble dietary fiber of at least about 1.25:1, at least about 1.3:1, at least about 1.35:1, at least about 1.4:1, at least about 1.5:1, at least about 1.7:1, at least about 2:1, at least about 2.5:1 or at least about 3:1. In certain embodiments, the protein-enriched soy composition has a ratio of high molecular weight soluble dietary fiber to the low molecular weight soluble dietary fiber of at least about 1.5:1. In certain other embodiments, the protein-enriched soy composition has a ratio of high molecular weight soluble dietary fiber to the low molecular weight soluble dietary fiber of at least about 2:1. In certain other embodiments, the protein-enriched soy composition has a ratio of high molecular weight soluble dietary fiber to the low molecular weight soluble dietary fiber of at least about 3:1.

In some embodiments, the protein-enriched soy composition has a content of low molecular weight soluble dietary fiber of less than or equal to about 40%, less than or equal to about 35%, less than or equal to about 30%, less than or equal to about 25% or less than or equal to about 20% of the total soluble dietary fiber present. In certain embodiments, the protein-enriched soy composition has a content of low molecular weight soluble dietary fiber of less than or equal to about 40% of the total soluble dietary fiber present. In certain other embodiments, the protein-enriched soy composition has a content of low molecular weight soluble dietary fiber of less than or equal to about 35% of the total soluble dietary fiber present. In certain other embodiments, the protein-enriched soy composition has a content of low molecular weight soluble dietary fiber of less than or equal to about 25% of the total soluble dietary fiber present.

### Fat Content

In some embodiments, the protein-enriched soy composition may be characterized by its crude fat content, for example, as determined by petroleum ether extraction methods in the art, or fat content as determined by acid or alkaline hydrolysis extraction methods. In some embodiments, the protein-enriched soy composition may be characterized by a crude fat composition. In certain embodiments, the protein-enriched soy composition may be characterized by a crude fat composition as determined by petroleum ether extraction. In other embodiments, the protein-enriched soy composition may be characterized by a fat composition as determined by acid hydrolysis.

In some embodiments, the protein-enriched soy composition provided herein has a crude fat composition of less than or equal to about 1%, less than or equal to about 0.7%, or less than or equal to about 0.5% on a dry weight basis. In some embodiments, the protein-enriched soy composition provided herein has less than or equal to about 1% on a dry weight basis.

In some embodiments, the protein-enriched soy composition provided herein has a crude fat composition of less than or equal to about 1%, less than or equal to about 0.7%, or less than or equal to about 0.5% on a dry weight basis as determined by petroleum ether extraction. In some embodiments, the protein-enriched soy composition provided herein has less than or equal to about 1% on a dry weight basis as determined by petroleum ether extraction.

### Ash and Moisture Content

In some embodiments, the protein-enriched soy composition has less than or equal to about 7%, less than or equal to about 6%, less than or equal to about 5%, or less than or equal to about 4% ash on a dry weight basis. In some embodiments, the protein-enriched soy composition has less than or equal to about 7% ash on a dry weight basis.

In some embodiments, the protein-enriched soy composition has less than or equal to about 10%, less than or equal to about 9%, less than or equal to about 8%, or less than or equal to about 7% moisture on a dry weight basis. In some embodiments, the protein-enriched soy composition has less than or equal to about 10% moisture on a dry weight basis.

### Other Components

In some embodiments, the protein-enriched soy composition has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched soy composition has any combinations of the above. In some embodiments, the protein-enriched soy composition has all of the above. In some embodiments, the improved characteristics as described above are improved as compared to the same properties of soy protein concentrate obtained from commodity soybeans.

In some embodiments, the protein-enriched soy composition provided herein is a soy protein concentrate.

In some embodiments, the protein-enriched soy composition provided herein has a higher concentration of certain compounds and relative to soy protein concentrate (SPC) compositions obtained from commodity soybeans.

In some embodiments, the protein-enriched soy composition has at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched soy composition provided herein has a concentration of β-conglycinin (7S soy protein) of at least about 50 mg/g. In some embodiments, the protein-enriched soy composition provided herein has at least about 10 ppm glycinin (11S soy protein). In some embodiments, the protein-enriched soy composition provided herein has at least about 10 ppm of lectins. In some embodiments, the protein-enriched soy composition provided herein has less than or equal to 20 mg isoflavones per 100 g protein-enriched soy composition.

In some embodiments, the protein-enriched soy composition comprises one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy composition. In some embodiments, the protein-enriched soy composition comprises any combination of (i)-(v). In some embodiments, the protein-enriched soy composition comprises any combination of (i)-(v). In some embodiments, the protein-enriched soy composition comprises all of (i)-(v). In some embodiments, the protein-enriched soy composition comprises all of (i)-(v).

### Functional Properties

As provided herein, the protein-enriched soy composition obtained according to the methods of the present disclosure comprises high protein content among other composition attributes described above. The compositional profiles of the protein-enriched soy composition contribute to the functional properties of the protein-enriched soy composition. The protein-enriched soy composition may be characterized by any number of functional properties, including but not limited to protein dispersibility, nitrogen/protein solubility, foaming properties, viscosity, water and oil holding capacities, emulsification properties, and/or gelling properties.

In some embodiments, any suitable methods known in the art or any of the protocols as described herein may be used to characterize the protein-enriched soy composition of the present disclosure by various functional properties. In some embodiments, the protein-enriched soy composition of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched soy composition, protein-enriched texturized soy composition, and protein-enriched re-functionalized soy composition described herein may be evaluated by any suitable methods known in the art and/or methods as described herein, such as in Example 2.

PDI may be measured using any suitable techniques known in the art. For example, in one variation, PDI is measured in accordance with the protocol set forth in Example 2, below.

In some embodiments, the protein-enriched soy composition provided herein has a PDI of less than or equal to about 30, less than or equal to about 20, less than or equal to about 10, or less than or equal to about 5. In some embodiments, the protein-enriched soy composition provided herein has a protein content of at least about 75% on a dry weight basis, and PDI of less than or equal to about 30, less than or equal to about 20, less than or equal to about 10, or less than or equal to about 5.

In some embodiments, the protein-enriched soy composition provided herein has at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched soy composition has any combinations of the above. In some embodiments, the protein-enriched soy composition has all of the above. In some embodiments, the improved characteristics as described above are improved as compared to the same properties of a soy protein concentrate obtained from commodity soybeans.

### Environmental Profile

In some embodiments, the protein-enriched soy composition provided herein has a more favorable environmental profile as compared to a protein-enriched soy composition prepared using commodity soybeans.

In some embodiments, having a favorable environmental comprises having a lower carbon footprint, requiring fewer resources to produce, or requiring less electricity to produce. In some embodiments, the carbon footprint of a soy composition reflects the total amount of carbon dioxide released into the atmosphere as a result of the processing of soybeans to produce the soy composition. In some embodiments, the carbon footprint of a soy composition reflects the total amount of carbon dioxide released into the atmosphere as a result of the cultivation, harvesting, transport, and processing of soybeans to produce the soy composition. In some embodiments, the carbon footprint of soybean cultivation includes emissions on field (e.g., emissions related to the use of lime or manure), diesel use in agricultural machinery, and production of pesticides and synthetic fertilizers. In some embodiments, the carbon footprint of soybean harvesting includes emissions from agricultural machinery and vehicles used to harvest the soybeans. In some embodiments, the carbon footprint of soybean transportation includes emissions from any vehicles used to transport the soybeans from the harvesting location to one or more processing locations. In some embodiments, the carbon footprint of processing the soybeans includes emissions associated with the generation of any heat used during processing (e.g., emissions from natural gas use), emissions from any electricity used during processing, and emissions associated with the production of any additives used during processing (e.g., emissions associated with the production of hexane, alcohols, or any other solvents used during processing).

In some embodiments, the protein-enriched soy composition provided herein has a lower carbon footprint as compared to a soy composition prepared using commodity soybeans. In some embodiments, the total amount of carbon dioxide released into the atmosphere as a result of the cultivation, harvesting, transport, and processing of soybeans to produce the protein-enriched soy composition is about 100%, at least about 90%, at least about 80%, at least about 70%, at least about 60%, at least about 50%, at least about 40%, at least about 30%, at least about 20%, at least about 10%, or at least about 5% less carbon dioxide than would be released during an analogous process to produce a soy composition from commodity soybeans. In some embodiments, the total amount of carbon dioxide released into the atmosphere as a result of the cultivation, harvesting, transport, and processing of soybeans to produce the protein-enriched soy composition is about 100%, about 90%, about 80%, about 70%, about 60%, about 50%, about 40%, about 30%, about 20%, about 10%, or about 5% less carbon dioxide than would be released during an analogous process to produce a soy composition from commodity soybeans.

In some embodiments, the protein-enriched soy composition provided herein has a higher protein content and a similar carbon footprint as compared to a soy composition prepared using commodity soybeans. In some embodiments, the protein-enriched soy composition has about 50% more, about 40% more, about 30% more, about 25% more, about 20% more, about 15% more, about 10% more, or about 5% more protein than a soy composition with a similar carbon footprint prepared using commodity soybeans.

In some embodiments, the protein-enriched soy composition provided herein has a lower carbon footprint than a soy composition with the same protein content prepared using commodity soybeans.

In some embodiments, the protein-enriched soy composition provided herein has a lower carbon footprint on a per-protein-weight basis as compared to a soy composition prepared using commodity soybeans. In some embodiments, the total amount of carbon dioxide released into the atmosphere as a result of the processing of the soybeans to produce the protein-enriched soy composition is less than would be released during the processing of commodity soybeans to produce a protein-enriched soy composition. In some embodiments, the total amount of carbon dioxide released into the atmosphere as a result of the cultivation, harvesting, transport, and processing of soybeans to produce the protein-enriched soy composition is less than would be released during the cultivation, harvesting, transport, and processing of commodity soybeans to produce a protein-enriched soy composition.

In some embodiments, the protein-enriched soy composition provided herein has a higher protein content and require a similar amount of water to produce as compared to a soy composition prepared using commodity soybeans. In some embodiments, the protein-enriched soy composition has about 50% more, about 40% more, about 30% more, about 25% more, about 20% more, about 15% more, about 10% more, or about 5% more protein than a soy composition prepared using commodity soybeans that requires a similar amount of water to produce.

In some embodiments, the protein-enriched soy composition provided herein requires less water to produce than a soy composition with the same protein content prepared using commodity soybeans. In some embodiments, the protein-enriched soy composition requires about 100%, at least about 90%, at least about 80%, at least about 70%, at least about 60%, at least about 50%, at least about 40%, at least about 30%, at least about 20%, at least about 10%, or at least about 5% less water to produce than a soy composition with the same protein content prepared using commodity soybeans. In some embodiments, the protein-enriched soy composition requires about 100%, about 90%, about 80%, about 70%, about 60%, about 50%, about 40%, about 30%, about 20%, about 10%, or about 5% less water to produce than a soy composition with the same protein content prepared using commodity soybeans.

In some embodiments, the protein-enriched soy composition provided herein requires less water to produce on a per-protein-weight basis than a soy composition prepared using commodity soybeans. In some embodiments, the protein-enriched soy composition requires about 100%, at least about 90%, at least about 80%, at least about 70%, at least about 60%, at least about 50%, at least about 40%, at least about 30%, at least about 20%, at least about 10%, or at least about 5% less water to produce on a per-protein-weight basis than a soy composition with the same protein content prepared using commodity soybeans. In some embodiments, the protein-enriched soy composition requires about 100%, about 90%, about 80%, about 70%, about 60%, about 50%, about 40%, about 30%, about 20%, about 10%, or about 5% less water to produce on a per-protein-weight basis than a soy composition with the same protein content prepared using commodity soybeans.

In some embodiments, the protein-enriched soy composition provided herein requires less electricity to produce than a soy composition with the same protein content prepared using commodity soybeans. In some embodiments, the protein-enriched soy composition requires about 100%, at least about 90%, at least about 80%, at least about 70%, at least about 60%, at least about 50%, at least about 40%, at least about 30%, at least about 20%, at least about 10%, or at least about 5% less electricity to produce than a soy composition with the same protein content prepared using commodity soybeans. In some embodiments, the protein-enriched soy composition requires about 100%, about 90%, about 80%, about 70%, about 60%, about 50%, about 40%, about 30%, about 20%, about 10%, or about 5% less electricity to produce than a soy composition with the same protein content prepared using commodity soybeans.

In some embodiments, the protein-enriched soy composition provided herein requires less electricity to produce on a per-protein-weight basis than a soy composition prepared using commodity soybeans. In some embodiments, the protein-enriched soy composition requires about 100%, at least about 90%, at least about 80%, at least about 70%, at least about 60%, at least about 50%, at least about 40%, at least about 30%, at least about 20%, at least about 10%, or at least about 5% less electricity to produce on a per-protein-weight basis than a soy composition with the same protein content prepared using commodity soybeans. In some embodiments, the protein-enriched soy composition requires about 100%, about 90%, about 80%, about 70%, about 60%, about 50%, about 40%, about 30%, about 20%, about 10%, or about 5% less electricity to produce on a per-protein-weight basis than a soy composition with the same protein content prepared using commodity soybeans.

### II. Protein-Enriched Texturized Soy Compositions

In one aspect, provided herein is a protein-enriched texturized soy composition. In another aspect, provided herein are protein-enriched texturized soy composition comprising at least about 70% soy protein on a dry weight basis.

In another aspect, provided is a protein-enriched texturized soy composition, comprising at least about 75% soy proteins on a dry weight basis, and a content of low molecular weight soluble dietary fiber is less than or equal to about 40% of the total soluble fiber content. In yet another aspect, provided herein is a protein-enriched texturized soy composition obtainable or produced by the methods according to the present disclosure. The compositions and properties of the protein-enriched soy compositions are described in further detail below.

Protein-enriched texturized soy compositions may be produced, for example, by extruding protein-enriched soy compositions as provided herein. This process is primarily mechanical in nature, and does not substantially change the chemical composition of the protein-enriched soy compositions, but may alter certain functional properties of the texturized soy composition. Accordingly, in some embodiments, provided is a protein-enriched texturized soy composition with substantially the same chemical composition as the protein-enriched soy composition from which it is produced. In other embodiments, provided is a protein-enriched texturized soy composition with functional properties which may be the same or different as the functional properties of the protein-enriched soy composition from which it is produced.

It should be understood that in some embodiments, the protein-enriched texturized soy composition disclosed herein may have a similar or identical composition as any of the protein-enriched soy compositions disclosed in embodiments of this application. In some embodiments, the protein-enriched texturized soy composition disclosed herein may have one or more similar or identical functional properties as any of the protein-enriched texturized soy composition disclosed in embodiments of this application.

### Soy Protein Content

The protein-enriched texturized soy composition provided herein has a high soy protein content, including relative to the soy protein content of the soybeans from which the protein-enriched texturized soy composition was obtained.

In some embodiments, the protein-enriched texturized soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% soy protein on a dry weight basis. In some embodiments, the protein-enriched texturized soy composition comprises at least about 70% soy protein on a dry weight basis. In some embodiments, the protein-enriched texturized soy composition comprises at least about 75% soy protein on a dry weight basis. In other embodiments, the protein-enriched texturized soy composition comprises at least about 80% protein on a dry weight basis. In some embodiments, the protein-enriched texturized soy composition comprises between about 70% and about 85% soy protein on a dry weight basis. In certain embodiments, the protein-enriched texturized soy composition has at least about 1.4 times, at least about 1.5 times, at least about 1.7 times, or at least about 2 times more soy protein per unit weight than the soybeans from which the protein-enriched soy composition was obtained. In some embodiments, the protein-enriched texturized soy composition comprises between about 1.4 and about 1.7 times more soy protein than the soybeans from which the protein-enriched texturized soy composition was obtained.

### Fiber or Carbohydrate Content

The present disclosure provides for methods of obtaining protein-enriched texturized soy compositions, involving treatment of defatted desolventized soybean compositions with polar solvents to remove soluble components, such as oligosaccharides, soluble fiber, and/or other soluble carbohydrates. As such, the low carbohydrate content of the protein-enriched texturized soy composition as provided herein reflects the methods through which the protein-enriched texturized soy composition can be obtained.

It should also be recognized that the protein-enriched texturized soy compositions of the present disclosure may comprise a particular profile of carbohydrates, including oligosaccharide content and soluble or insoluble fiber ratios, reflective of the methods of the present disclosure. The carbohydrate and/or fiber composition of the protein-enriched texturized soy compositions may distinguish the protein-enriched texturized soy compositions from other commercially available soy products prepared from blends of soy flours, soy protein concentrates, and/or soy protein isolates. It should be further recognized that the carbohydrate and/or fiber profiles of the protein-enriched texturized soy compositions provided herein may contribute to their functional properties. In some embodiments, the protein-enriched texturized soy composition is unblended, and is substantially free of soy protein concentrate obtained from commodity soybeans or soy protein isolate obtained from commodity soybeans.

In some embodiments, the protein-enriched texturized soy composition may be characterized by its total sugar content. In other embodiments, the protein-enriched texturized soy composition may be characterized by its oligosaccharide content. In certain embodiments, the protein-enriched texturized soy composition may be characterized by the content of one or more individual oligosaccharides, including but not limited to raffinose, stachyose, fructose, glucose, sucrose, maltose, and lactose. In some such embodiments, the protein-enriched texturized soy composition comprises less than or equal to about 2%, less than or equal to about 1%, less than or equal to about 0.7% or less than or equal to about 0.5% total sugars on a dry weight basis. In some such embodiments, the protein-enriched texturized soy composition comprises less than or equal to about 2%, less than or equal to about 1%, less than or equal to about 0.7% or less than or equal to about 0.5% oligosaccharides on a dry weight basis.

In some embodiments, the protein-enriched texturized soy composition may be characterized by the content of certain oligosaccharides, including but not limited to sucrose, stachyose, and raffinose, which contribute to the total sugar content. In some embodiments, the protein-enriched texturized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% of any individual oligosaccharide on a dry weight basis. In some embodiments, the protein-enriched texturized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% sucrose on a dry weight basis. In some embodiments, the protein-enriched texturized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% stachyose on a dry weight basis. In some embodiments, the protein-enriched texturized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% raffinose on a dry weight basis.

In some embodiments, the protein-enriched texturized soy composition provided herein may be characterized by the total dietary fiber content or any other subcategories of dietary fiber. Some subcategories of dietary fiber include soluble dietary fiber (SDF), insoluble dietary fiber (IDF), resistant starch (RF), high molecular weight dietary fiber which further encompasses high molecular weight insoluble dietary fiber (HMWIDF) and high molecular weight soluble dietary fiber (HMWSDF), and low molecular weight soluble dietary fiber (LMWSDF). These subcategories are defined as provided in the CODEX Alimentarius (2008).

In some embodiments, the protein-enriched texturized soy composition provided herein has a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched texturized soy composition provided herein has a total dietary fiber of less than or equal to about 25%.

In some embodiments, the protein-enriched texturized soy composition provided herein has less than or equal to about 27%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% insoluble dietary fiber on a dry weight basis. In some embodiments, the protein-enriched texturized soy composition provided herein has an insoluble dietary fiber content of less than or equal to about 25% on a dry weight basis.

In some embodiments, the protein-enriched texturized soy composition of the present disclosure has less than or equal to about 5%, less than or equal to about 4.5%, less than or equal to about 4%, less than or equal to about 3.5%, or less than or equal to about 3% soluble dietary fiber on a dry weight basis. In certain embodiments, the protein-enriched texturized soy composition of the present disclosure has less than or equal to about 4% soluble dietary fiber on a dry weight basis. In certain other embodiments, the protein-enriched texturized soy composition of the present disclosure has less than or equal to about 3% soluble dietary fiber on a dry weight basis.

In some embodiments, the protein-enriched texturized soy composition has a content of high molecular weight soluble dietary fiber of less than or equal to about 3%, less than or equal to about 2.7%, less than or equal to about 2.5%, less than or equal to about 2.2%, less than or equal to about 2%, or less than or equal to about 1.7% on a dry weight basis. In certain embodiments, the protein-enriched texturized soy composition has a content of high molecular weight soluble dietary fiber of less than or equal to about 2.5%.

In some embodiments, the protein-enriched texturized soy composition has a content of low molecular weight soluble dietary fiber of less than or equal to about 2%, less than or equal to about 1.7%, less than or equal to about 1.5%, less than or equal to about 1.2%, less than or equal to about 1%, or less than or equal to about 0.9% on a dry weight basis. In certain embodiments, the protein-enriched texturized soy composition has a content of low molecular weight soluble dietary fiber of less than or equal to about 1.5%.

In still other embodiments, the protein-enriched texturized soy composition may be characterized by the ratio of high molecular weight soluble dietary fiber to the low molecular weight soluble dietary fiber, or the percentages of high molecular weight and low molecular weight soluble dietary fiber out of the total soluble dietary fiber present. For example, in some embodiments, the protein-enriched texturized soy composition has a ratio of high molecular weight soluble dietary fiber to the low molecular weight soluble dietary fiber of at least about 1.25:1, at least about 1.3:1, at least about 1.35:1, at least about 1.4:1, at least about 1.5:1, at least about 1.7:1, at least about 2:1, at least about 2.5:1 or at least about 3:1. In certain embodiments, the protein-enriched texturized soy composition has a ratio of high molecular weight soluble dietary fiber to the low molecular weight soluble dietary fiber of at least about 1.5:1. In certain other embodiments, the protein-enriched texturized soy composition has a ratio of high molecular weight soluble dietary fiber to the low molecular weight soluble dietary fiber of at least about 2:1. In certain other embodiments, the protein-enriched texturized soy composition has a ratio of high molecular weight soluble dietary fiber to the low molecular weight soluble dietary fiber of at least about 3:1.

In some embodiments, the protein-enriched texturized soy composition has a content of low molecular weight soluble dietary fiber of less than or equal to about 40%, less than or equal to about 35%, less than or equal to about 30%, less than or equal to about 25% or less than or equal to about 20% of the total soluble dietary fiber present. In certain embodiments, the protein-enriched texturized soy composition has a content of low molecular weight soluble dietary fiber of less than or equal to about 40% of the total soluble dietary fiber present. In certain other embodiments, the protein-enriched texturized soy composition has a content of low molecular weight soluble dietary fiber of less than or equal to about 35% of the total soluble dietary fiber present. In certain other embodiments, the protein-enriched texturized soy composition has a content of low molecular weight soluble dietary fiber of less than or equal to about 25% of the total soluble dietary fiber present.

### Fat Content

In some embodiments, the protein-enriched texturized soy composition may be characterized by its crude fat content, for example, as determined by petroleum ether extraction methods in the art, or fat content as determined by acid or alkaline hydrolysis extraction methods. In some embodiments, the protein-enriched texturized soy composition may be characterized by a crude fat composition. In certain embodiments, the protein-enriched texturized soy composition may be characterized by a crude fat composition as determined by petroleum ether extraction. In other embodiments, the protein-enriched texturized soy composition may be characterized by a fat composition as determined by acid hydrolysis.

In some embodiments, the protein-enriched texturized soy composition provided herein has a crude fat composition of less than or equal to about 1%, less than or equal to about 0.7%, or less than or equal to about 0.5% on a dry weight basis. In some embodiments, the protein-enriched texturized soy composition provided herein has less than or equal to about 1% on a dry weight basis.

In some embodiments, the protein-enriched texturized soy composition provided herein has a crude fat composition of less than or equal to about 1%, less than or equal to about 0.7%, or less than or equal to about 0.5% on a dry weight basis as determined by petroleum ether extraction. In some embodiments, the protein-enriched texturized soy composition provided herein has less than or equal to about 1% on a dry weight basis as determined by petroleum ether extraction.

### Ash and Moisture Content

In some embodiments, the protein-enriched texturized soy composition has less than or equal to about 7%, less than or equal to about 6%, less than or equal to about 5%, or less than or equal to about 4% ash on a dry weight basis. In some embodiments, the protein-enriched texturized soy composition has less than or equal to about 7% ash on a dry weight basis.

In some embodiments, the protein-enriched texturized soy composition has less than or equal to about 10%, less than or equal to about 9%, less than or equal to about 8%, or less than or equal to about 7% moisture on a dry weight basis. In some embodiments, the protein-enriched texturized soy composition has less than or equal to about 10% moisture on a dry weight basis.

### Other Components

In some embodiments, the protein-enriched texturized soy composition has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched texturized soy composition has any combinations of the above. In some embodiments, the protein-enriched texturized soy composition has all of the above. In some embodiments, the improved characteristics as described above are improved as compared to the same properties of soy protein concentrate obtained from commodity soybeans.

In some embodiments, the protein-enriched texturized soy composition provided herein has a higher concentration of certain compounds and relative to soy protein concentrate (SPC) compositions obtained from commodity soybeans.

In some embodiments, the protein-enriched texturized soy composition has at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched texturized soy composition provided herein has a concentration of β-conglycinin (7S soy protein) of at least about 50 mg/g. In some embodiments, the protein-enriched texturized soy composition provided herein has at least about 10 ppm glycinin (11S soy protein). In some embodiments, the protein-enriched texturized soy composition provided herein has at least about 10 ppm of lectins. In some embodiments, the protein-enriched texturized soy composition provided herein has less than or equal to 20 mg isoflavones per 100 g protein-enriched soy composition.

In some embodiments, the protein-enriched texturized soy composition comprises one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched texturized soy composition. In some embodiments, the protein-enriched texturized soy composition comprises any combination of (i)-(v). In some embodiments, the protein-enriched texturized soy composition comprises any combination of (i)-(v). In some embodiments, the protein-enriched texturized soy composition comprises all of (i)-(v). In some embodiments, the protein-enriched texturized soy composition comprises all of (i)-(v).

### Functional Properties

As provided herein, the protein-enriched texturized soy composition obtained according to the methods of the present disclosure comprises high protein content among other composition attributes described above. The compositional profiles of the protein-enriched texturized soy composition contribute to the functional properties of the protein-enriched texturized soy composition. The protein-enriched soy composition may be characterized by any number of functional properties, including but not limited to protein dispersibility, nitrogen/protein solubility, foaming properties, viscosity, water and oil holding capacities, emulsification properties, and/or gelling properties.

In some embodiments, the protein-enriched texturized soy composition of the present disclosure may be characterized by various functional properties according to any suitable methods known in the art or according to any of the protocols as described herein. In some embodiments, the protein-enriched texturized soy composition of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched soy composition, protein-enriched texturized soy composition, and protein-enriched re-functionalized soy composition described herein may be evaluated by any suitable methods known in the art and/or methods as described herein, such as in Example 2.

PDI may be measured using any suitable techniques known in the art. For example, in one variation, PDI is measured in accordance with the protocol set forth in Example 2, below.

In some embodiments, the protein-enriched texturized soy composition provided herein has a PDI of less than or equal to about 30, less than or equal to about 20, less than or equal to about 10, or less than or equal to about 5. In some embodiments, the protein-enriched texturized soy composition provided herein has a protein content of at least about 75% on a dry weight basis, and PDI of less than or equal to about 30, less than or equal to about 20, less than or equal to about 10, or less than or equal to about 5.

In some embodiments, the protein-enriched texturized soy composition provided herein has at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched texturized soy composition has any combinations of the above. In some embodiments, the protein-enriched texturized soy composition has all of the above. In some embodiments, the improved characteristics as described above are improved as compared to the same properties of a soy protein concentrate obtained from commodity soybeans.

### III. Protein-Enriched Re-Functionalized Soy Compositions

In one aspect, provided herein is a protein-enriched re-functionalized soy composition. In another aspect, provided herein are protein-enriched re-functionalized soy composition comprising at least about 70% soy protein on a dry weight basis. In another aspect, provided is a protein-enriched re-functionalized soy composition, comprising at least about 75% soy proteins on a dry weight basis, and a content of low molecular weight soluble dietary fiber is less than or equal to about 40% of the total soluble fiber content. In some embodiments, provided is a protein-enriched re-functionalized soy composition, comprising at least about 75% soy proteins on a dry weight basis, and a content of low molecular weight soluble dietary fiber is less than or equal to about 40% of the total soluble fiber content, wherein the protein-enriched re-functionalized soy composition has a protein dispersibility index of at least 70%. In one aspect, provided herein is a protein-enriched re-functionalized soy composition obtainable or produced by the methods according to the present disclosure.

Protein-enriched re-functionalized soy composition compositions may be produced by treatments of protein-enriched soy composition as described herein, including but not limited to hydrothermal cooking, or hydration followed by spray-drying. This process is does not substantially change the chemical composition of the protein-enriched re-functionalized soy composition relative to the initial protein-enriched soy composition, but may alter the functional properties of the re-functionalized soy composition. Accordingly, in some embodiments, provided is a protein-enriched re-functionalized soy composition with substantially the same chemical composition as the protein-enriched soy composition from which it is produced. In other embodiments, provided is a protein-enriched re-functionalized soy composition with functional properties which may be the same or different as the functional properties of the protein-enriched soy composition from which it is produced.

### Soy Protein Content

The protein-enriched re-functionalized soy composition provided herein has a high soy protein content, including relative to the soy protein content of the soybeans from which the protein-enriched re-functionalized soy composition was obtained.

In some embodiments, the protein-enriched re-functionalized soy composition provided herein comprises at least about 70%, at least about 71%, at least about 72%, at least about 73%, at least about 74%, at least about 75%, at least about 76%, at least about 77%, at least about 78%, at least about 79%, at least about 80%, at least about 82%, at least about 83%, at least about 84%, or at least about 85% soy protein on a dry weight basis. In some embodiments, the protein-enriched re-functionalized soy composition comprises at least about 70% soy protein on a dry weight basis. In some embodiments, the protein-enriched re-functionalized soy composition comprises at least about 75% soy protein on a dry weight basis. In other embodiments, the protein-enriched re-functionalized soy composition comprises at least about 80% protein on a dry weight basis. In some embodiments, the protein-enriched re-functionalized soy composition comprises between about 70% and about 85% soy protein on a dry weight basis.

In certain embodiments, the protein-enriched re-functionalized soy composition has at least about 1.4 times, at least about 1.5 times, at least about 1.7 times, or at least about 2 times more soy protein per unit weight than the soybeans from which the protein-enriched re-functionalized soy composition was obtained. In some embodiments, the protein-enriched re-functionalized soy composition comprises between about 1.4 and about 1.7 times more soy protein than the soybeans from which the protein-enriched re-functionalized soy composition was obtained.

### Fiber or Carbohydrate Content

The present disclosure provides for methods of obtaining protein-enriched re-functionalized soy compositions, involving treatment of defatted desolventized soybean compositions with polar solvents to remove soluble components, such as oligosaccharides, soluble fiber, and/or other soluble carbohydrates. As such, the low carbohydrate content of the protein-enriched re-functionalized soy composition as provided herein reflects the methods through which the protein-enriched re-functionalized soy composition can be obtained.

It should also be recognized that the protein-enriched re-functionalized soy compositions of the present disclosure may comprise a particular profile of carbohydrates, including oligosaccharide content and soluble or insoluble fiber ratios, reflective of the methods of the present disclosure. The carbohydrate and/or fiber composition of the protein-enriched re-functionalized soy compositions may distinguish the protein-enriched re-functionalized soy compositions from other commercially available soy products prepared from blends of soy flours, soy protein concentrates, and/or soy protein isolates. It should be further recognized that the carbohydrate and/or fiber profiles of the protein-enriched re-functionalized soy compositions provided herein may contribute to their functional properties. In some embodiments, the protein-enriched re-functionalized soy composition is unblended, and is substantially free of soy protein concentrate obtained from commodity soybeans or soy protein isolate obtained from commodity soybeans.

In some embodiments, the protein-enriched re-functionalized soy composition may be characterized by its total sugar content. In other embodiments, the protein-enriched re-functionalized soy composition may be characterized by its oligosaccharide content. In certain embodiments, the protein-enriched re-functionalized soy composition may be characterized by the content of one or more individual oligosaccharides, including but not limited to raffinose, stachyose, fructose, glucose, sucrose, maltose, and lactose. In some such embodiments, the protein-enriched re-functionalized soy composition comprises less than or equal to about 2%, less than or equal to about 1%, less than or equal to about 0.7% or less than or equal to about 0.5% total sugars on a dry weight basis. In some such embodiments, the protein-enriched re-functionalized soy composition comprises less than or equal to about 2%, less than or equal to about 1%, less than or equal to about 0.7% or less than or equal to about 0.5% oligosaccharides on a dry weight basis.

In some embodiments, the protein-enriched re-functionalized soy composition may be characterized by the content of certain mono-, di- or oligosaccharides, including but not limited to sucrose, stachyose, and raffinose, which contribute to the total sugar content. In some embodiments, the protein-enriched re-functionalized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% of any individual mono-, di- or oligosaccharide on a dry weight basis. In some embodiments, the protein-enriched re-functionalized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% sucrose on a dry weight basis. In some embodiments, the protein-enriched re-functionalized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% stachyose on a dry weight basis. In some embodiments, the protein-enriched re-functionalized soy composition comprises less than or equal to about 0.5%, less than or equal to about 0.4%, less than or equal to about 0.3%, less than or equal to about 0.2%, less than or equal to about 0.1%, less than or equal to about 0.05%, or less than or equal to about 0.01% raffinose on a dry weight basis.

In some embodiments, the protein-enriched re-functionalized soy composition provided herein may be characterized by the total dietary fiber content or any other subcategories of dietary fiber. Some subcategories of dietary fiber include soluble dietary fiber (SDF), insoluble dietary fiber (IDF), resistant starch (RF), high molecular weight dietary fiber which further encompasses high molecular weight insoluble dietary fiber (HMWIDF) and high molecular weight soluble dietary fiber (HMWSDF), and low molecular weight soluble dietary fiber (LMWSDF). These subcategories are defined as provided in the CODEX Alimentarius (2008).

In some embodiments, the protein-enriched re-functionalized soy composition provided herein has a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched re-functionalized soy composition provided herein has a total dietary fiber of less than or equal to about 25%.

In some embodiments, the protein-enriched re-functionalized soy composition provided herein has less than or equal to about 27%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% insoluble dietary fiber on a dry weight basis. In some embodiments, the protein-enriched re-functionalized soy composition provided herein has an insoluble dietary fiber content of less than or equal to about 25% on a dry weight basis.

In some embodiments, the protein-enriched re-functionalized soy composition of the present disclosure has less than or equal to about 5%, less than or equal to about 4.5%, less than or equal to about 4%, less than or equal to about 3.5%, or less than or equal to about 3% soluble dietary fiber on a dry weight basis. In certain embodiments, the protein-enriched re-functionalized soy composition of the present disclosure has less than or equal to about 4% soluble dietary fiber on a dry weight basis. In certain other embodiments, the protein-enriched re-functionalized soy composition of the present disclosure has less than or equal to about 3% soluble dietary fiber on a dry weight basis.

In some embodiments, the protein-enriched re-functionalized soy composition has a content of high molecular weight soluble dietary fiber of less than or equal to about 3%, less than or equal to about 2.7%, less than or equal to about 2.5%, less than or equal to about 2.2%, less than or equal to about 2%, or less than or equal to about 1.7% on a dry weight basis. In certain embodiments, the protein-enriched re-functionalized soy composition has a content of high molecular weight soluble dietary fiber of less than or equal to about 2.5%.

In some embodiments, the protein-enriched re-functionalized soy composition has a content of low molecular weight soluble dietary fiber of less than or equal to about 2%, less than or equal to about 1.7%, less than or equal to about 1.5%, less than or equal to about 1.2%, less than or equal to about 1%, or less than or equal to about 0.9% on a dry weight basis. In certain embodiments, the protein-enriched re-functionalized soy composition has a content of low molecular weight soluble dietary fiber of less than or equal to about 1.5%.

In still other embodiments, the protein-enriched re-functionalized soy composition may be characterized by the ratio of high molecular weight soluble dietary fiber to the low molecular weight soluble dietary fiber, or the percentages of high molecular weight and low molecular weight soluble dietary fiber out of the total soluble dietary fiber present. For example, in some embodiments, the protein-enriched re-functionalized soy composition has a ratio of high molecular weight soluble dietary fiber to the low molecular weight soluble dietary fiber of at least about 1.25:1, at least about 1.3:1, at least about 1.35:1, at least about 1.4:1, at least about 1.5:1, at least about 1.7:1, at least about 2:1, at least about 2.5:1 or at least about 3:1. In certain embodiments, the protein-enriched re-functionalized soy composition has a ratio of high molecular weight soluble dietary fiber to the low molecular weight soluble dietary fiber of at least about 1.5:1. In certain other embodiments, the protein-enriched re-functionalized soy composition has a ratio of high molecular weight soluble dietary fiber to the low molecular weight soluble dietary fiber of at least about 2:1. In certain other embodiments, the protein-enriched re-functionalized soy composition has a ratio of high molecular weight soluble dietary fiber to the low molecular weight soluble dietary fiber of at least about 3:1.

In some embodiments, the protein-enriched re-functionalized soy composition has a content of low molecular weight soluble dietary fiber of less than or equal to about 40%, less than or equal to about 35%, less than or equal to about 30%, less than or equal to about 25% or less than or equal to about 20% of the total soluble dietary fiber present. In certain embodiments, the protein-enriched re-functionalized soy composition has a content of low molecular weight soluble dietary fiber of less than or equal to about 40% of the total soluble dietary fiber present. In certain other embodiments, the protein-enriched re-functionalized soy composition has a content of low molecular weight soluble dietary fiber of less than or equal to about 35% of the total soluble dietary fiber present. In certain other embodiments, the protein-enriched re-functionalized soy composition has a content of low molecular weight soluble dietary fiber of less than or equal to about 25% of the total soluble dietary fiber present.

### Fat Content

In some embodiments, the protein-enriched re-functionalized soy composition may be characterized by its crude fat content, for example, as determined by petroleum ether extraction methods in the art, or fat content as determined by acid or alkaline hydrolysis extraction methods. In some embodiments, the protein-enriched re-functionalized soy composition may be characterized by a crude fat composition. In certain embodiments, the protein-enriched re-functionalized soy composition may be characterized by a crude fat composition as determined by petroleum ether extraction. In other embodiments, the protein-enriched re-functionalized soy composition may be characterized by a fat composition as determined by acid hydrolysis.

In some embodiments, the protein-enriched re-functionalized soy composition provided herein has a crude fat composition of less than or equal to about 1%, less than or equal to about 0.7%, or less than or equal to about 0.5% on a dry weight basis. In some embodiments, the protein-enriched re-functionalized soy composition provided herein has less than or equal to about 1% on a dry weight basis.

In some embodiments, the protein-enriched re-functionalized soy composition provided herein has a crude fat composition of less than or equal to about 1%, less than or equal to about 0.7%, or less than or equal to about 0.5% on a dry weight basis as determined by petroleum ether extraction. In some embodiments, the protein-enriched re-functionalized soy composition provided herein has less than or equal to about 1% on a dry weight basis as determined by petroleum ether extraction.

### Ash and Moisture Content

In some embodiments, the protein-enriched re-functionalized soy composition has less than or equal to about 7%, less than or equal to about 6%, less than or equal to about 5%, or less than or equal to about 4% ash on a dry weight basis. In some embodiments, the protein-enriched re-functionalized soy composition has less than or equal to about 7% ash on a dry weight basis.

In some embodiments, the protein-enriched re-functionalized soy composition has less than or equal to about 10%, less than or equal to about 9%, less than or equal to about 8%, or less than or equal to about 7% moisture on a dry weight basis. In some embodiments, the protein-enriched re-functionalized soy composition has less than or equal to about 10% moisture on a dry weight basis.

### Other Components

In some embodiments, the protein-enriched re-functionalized soy composition has at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched re-functionalized soy composition has any combinations of the above. In some embodiments, the protein-enriched re-functionalized soy composition has all of the above. In some embodiments, the improved characteristics as described above are improved as compared to the same properties of soy protein concentrate obtained from commodity soybeans.

In some embodiments, the protein-enriched re-functionalized soy composition provided herein has a higher concentration of certain compounds and relative to soy protein concentrate (SPC) compositions obtained from commodity soybeans.

In some embodiments, the protein-enriched re-functionalized soy composition has at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched re-functionalized soy composition provided herein has a concentration of β-conglycinin (7S soy protein) of at least about 50 mg/g. In some embodiments, the protein-enriched re-functionalized soy composition provided herein has at least about 10 ppm glycinin (11S soy protein). In some embodiments, the protein-enriched re-functionalized soy composition provided herein has at least about 10 ppm of lectins. In some embodiments, the protein-enriched re-functionalized soy composition provided herein has less than or equal to 20 mg isoflavones per 100 g protein-enriched re-functionalized soy composition.

In some embodiments, the protein-enriched re-functionalized soy composition comprises one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy composition. In some embodiments, the protein-enriched re-functionalized soy composition comprises any combination of (i)-(v). In some embodiments, the protein-enriched re-functionalized soy composition comprises any combination of (i)-(v). In some embodiments, the protein-enriched re-functionalized soy composition comprises all of (i)-(v). In some embodiments, the protein-enriched re-functionalized soy composition comprises all of (i)-(v).

### Functional Properties

As provided herein, the protein-enriched re-functionalized soy composition obtained according to the methods of the present disclosure comprises high protein content among other composition attributes described above. The compositional profiles of the protein-enriched re-functionalized soy composition contribute to the functional properties of the protein-enriched re-functionalized soy composition. The protein-enriched re-functionalized soy composition may be characterized by any number of functional properties, including but not limited to protein dispersibility, nitrogen/protein solubility, foaming properties, viscosity, water and oil holding capacities, emulsification properties, and/or gelling properties.

In some embodiments, the protein-enriched re-functionalized soy composition of the present disclosure may be characterized by various functional properties according to any suitable methods known in the art or according to any of the protocols as described herein. In some embodiments, the protein-enriched re-functionalized soy composition of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched soy composition, protein-enriched texturized soy composition, and protein-enriched re-functionalized soy composition described herein may be evaluated by any suitable methods known in the art and/or methods as described herein, such as in Example 2.

As detailed above, the protein-enriched soy compositions may be subjected to additional treatments, such as hydrothermal cooking, to restore functionality to protein-enriched soy compositions, which was otherwise reduced or removed as a result of extraction with polar solvents to remove soluble components. By virtue of the additional treatments to restore functionality, the resulting protein-enriched re-functionalized soy composition may exhibit improvements in the functional properties of the protein-enriched re-functionalized soy composition as compared to protein-enriched soy composition or protein-enriched texturized soy composition. For example, in some embodiments, the protein-enriched re-functionalized soy composition has a PDI greater than the protein-enriched soy composition from which it was obtained.

PDI may be measured using any suitable techniques known in the art. For example, in one variation, PDI is measured in accordance with the protocol set forth in Example 2, below.

In some embodiments, the re-functionalized soy composition provided herein has a PDI of at least about 20, at least about 30, at least about 40, at least about 50, at least about 60, at least about 65, at least about 70, at least about 75, at least about 80, or at least about 90. In some embodiments, the protein-enriched re-functionalized soy composition provided herein has a protein content of at least about 75% on a dry weight basis, and PDI of at least about 20, at least about 30, at least about 40, at least about 50, at least about 60, at least about 65, at least about 70, at least about 75, at least about 80, or at least about 90.

In some embodiments, the protein-enriched re-functionalized soy composition provided herein has at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched re-functionalized soy composition has any combinations of the above. In some embodiments, the protein-enriched re-functionalized soy composition has all of the above. In some embodiments, the improved characteristics as described above are improved as compared to the same properties of a soy protein concentrate obtained from commodity soybeans.

### C. Uses of Compositions

The protein-enriched texturized soy compositions, and protein-enriched re-functionalized soy compositions as provided herein may exhibit one or more particular physicochemical properties or functionalities which makes these protein-enriched soy compositions especially suitable for certain uses, particularly use in food products.

In certain aspects, provided are also food and beverage products incorporating or produced using the protein-enriched soy compositions herein. Such protein-enriched soy compositions may be used for protein fortification in various food and beverage products, including for example, in juice based high acid beverages, allergen-free non-dairy low acid beverages, plant-based yogurts, plant-based ice-creams, bakery products, baked snacks, cream soups, meat analogs, and cheese analogs.

In some embodiments, suitable food products may include, for example, soups, sauces, salad dressings, hummus, breads, cookies, crackers, nutritional bars, meal replacement products, and snacks. In some variations, the food product incorporating or produced from the protein-enriched soy compositions herein is a bakery product.

In some embodiments, beverages may include, for example, high-acid beverages, neutral beverages, carbonated beverages, non-carbonated beverages, high protein beverages, and meal replacement beverages.

As described herein, the properties of the protein-enriched soy compositions may be used as ingredients in various food applications. The protein-enriched soy compositions, or ingredients, as provided herein possess a number of favorable properties in addition to their high protein content, which makes them suitable for a wide-array of food and beverage products. With respect to certain applications, the protein-enriched soy compositions provided herein may demonstrate comparable and, in certain circumstances, superior properties as compared to other soy ingredients or soy compositions in the market, and thus may be advantageously incorporated into specific food products over competitor soy products. Exemplary products may include but are not limited to beverage products such as ready-to-drink beverages or protein shake powders, dairy product substitutes including plant-based yogurt, cheese or milks, meat substitute products such as plant-based burgers, and egg substitutes.

In some variations of the foregoing, the food or beverage products have at least about 1, at least about 2, at least about 3, at least about 4, at least about 5, at least about 6, at least about 7, at least about 8, at least about 9, at least about 10 grams, at least about 12 g, at least about 15 g, or at least about 17 g of soy protein per serving. In some variations, the food or beverage products have between about 1 g and about 20 g of soy protein per serving. In certain variations, at least about 10%, at least about 20%, at least about 25%, at least about 30%, at least about 40%, at least about 50%, at least about 60%, at least about 70%, at least about 75%, at least about 80%, at least about 90%, or at least about 95% by weight of the protein in the food or beverage product is from soy protein.

The food and beverages products can include various other components other than the protein-enriched soy compositions described herein. For example, the food and beverage products may include, for example, water, flour, fats and oils, sweeteners (such as sugar), salt, leavening agents, fruit and vegetable juices, thickeners (such as pectin and other hydro colloids), anti-foaming agents, natural and artificial flavorings, preservatives, and coloring agents.

In some embodiments, certain protein-enriched soy compositions may be especially suitable for use in certain food and/or beverage products. For example, in some embodiments, protein-enriched texturized soy compositions may be included in meat substitute products. In other embodiments, protein-enriched re-functionalized soy compositions may be included in beverage or bakery products containing high oil or fat content.

In another aspect, provided is a method of preparing food and/or beverages products. Such methods may include one or more of mixing/blending, pasteurizing and/or sterilizing, baking, fermenting, carbonating, leavening, and packaging.

In other aspects, the protein-enriched soy compositions herein may be used as or incorporated into pharmaceutical products. In certain variations of the foregoing aspect, the protein-enriched soy compositions have a pharmaceutical-grade purity. In other variations, the protein-enriched soy compositions have a protein purity of greater than or equal to about 99%.

In other aspects, the protein-enriched soy compositions herein may be used as or incorporated into dietary supplement products. In certain variations of the foregoing aspect, the protein-enriched soy compositions have a dietary supplement-grade purity. In other variations, the protein-enriched soy compositions have a protein purity of greater than or equal to about 99%.

In other aspects, the protein-enriched soy compositions herein may be used as or incorporated into cosmetic products. In certain variations of the foregoing aspect, the protein-enriched soy compositions have a cosmetic-grade purity. In other variations, the protein-enriched soy compositions have a protein purity of greater than or equal to about 99%.

In other aspects, the protein-enriched soy compositions herein may be used as or incorporated into medical foods. In certain variations of the foregoing aspect, the protein-enriched soy compositions have a medical food-grade purity. In other variations, the protein-enriched soy compositions have a protein purity of greater than or equal to about 99%.

In other aspects, the protein-enriched soy compositions herein may be used as or incorporated into infant formula products. In certain variations of the foregoing aspect, the protein-enriched soy compositions have an infant formula-grade purity. In other variations, the protein-enriched soy compositions have a protein purity of greater than or equal to about 99%.

### ENUMERATED EMBODIMENTS

In some embodiments, provided herein are the following enumerated embodiments:

Embodiment 1. A method of producing a protein-enriched soy composition, the method comprising:
a) providing soybeans, wherein at least a portion of the soybeans has a protein content of at least about 42% soy proteins on a dry weight basis;
b) defatting the soybeans by solvent extraction to produce a defatted soybean composition;
c) desolventizing the defatted soybean composition to directly produce a defatted desolventized soybean composition that comprises at least about 60% soy proteins on a dry weight basis;
d) contacting the defatted desolventized soybean composition with polar solvent to remove soluble components to produce a concentrated soy composition, and
e) desolventizing the concentrated soy composition to produce a protein-enriched soy protein composition that comprises at least about 75% soy proteins on a dry weight basis.
   Embodiment 2. The method embodiment 1, wherein the polar solvent comprises alcohol or water, or a mixture thereof.
   Embodiment 3. The method embodiment 2, wherein the alcohol is ethanol.
   Embodiment 4. The method of embodiment 1, wherein the polar solvent does not contain alcohol.
   Embodiment 5. The method of any one of embodiments 1-4, wherein at least a portion of the soybeans provided in step a) has a protein content of at least about 45% soy proteins on a dry weight basis.
   Embodiment 6. The method of any one of embodiments 1-4, wherein at least a portion of the soybeans provided in step a) has a protein content of at least about 48% soy proteins on a dry weight basis.
   Embodiment 7. The method of any one of embodiments 1-6, wherein the method further comprises dehulling the soybeans, and optionally mechanically flaking or grinding the dehulled beans, prior to the defatting step.
   Embodiment 8. The method of any one of embodiments 1-5, wherein the method further comprises flaking the soybeans prior to the defatting step.
   Embodiment 9. The method of any one of embodiments 1-8, wherein the soy protein composition comprises one or more of (i) to (iv):
(i) less than or equal to about 1% crude fat on a dry weight basis as determined by petroleum ether extraction;
(ii) less than or equal to about 25% total dietary fiber on a dry weight basis;
(iii) less than or equal to about 4% soluble dietary fiber on a dry weight basis; or
(iv) a content of low molecular weight soluble dietary fiber less than or equal to about 40% of the total soluble dietary fiber present.
   Embodiment 10. The method of any one of embodiments 1-9, wherein the protein-enriched soy composition produced has one or more improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, and higher concentration of steric acid, or any combination thereof, as compared to a soy protein concentrate or soy protein isolate produced from commodity soybeans.
   Embodiment 11. The method of any of embodiments 1-10, wherein the protein-enriched soy composition produced has a reduced quantity of lipoxygenase enzyme as compared as compared to a soy protein concentrate or soy protein isolate produced from commodity soybeans, as determined by SDS-PAGE.
   Embodiment 12. The method of any of embodiments 1-11, further comprising extruding the protein-enriched soy composition produced to provide a protein-enriched texturized soy composition.
   Embodiment 13. The method of any one of embodiments 1-11, further comprising hydrothermally cooking the protein-enriched soy composition produced, and drying the cooked protein-enriched soy composition to provide a protein-enriched re-functionalized soy composition.
   Embodiment 14. The method of embodiment 13, wherein the protein-enriched re-functionalized soy composition produced has a protein dispersibility index of at least 70.
   Embodiment 15. A protein-enriched soy composition produced according to the method of any one of embodiments 1-14.
   Embodiment 16. A protein-enriched texturized soy composition produced according to the method of embodiment 12.
   Embodiment 17. A protein-enriched re-functionalized soy composition produced according to the method of embodiment 14.
   Embodiment 18. A protein-enriched soy composition, comprising at least about 75% soy proteins on a dry weight basis, and a content of low molecular weight soluble dietary fiber is less than or equal to about 40% of the total soluble fiber content.
   Embodiment 19. The protein-enriched soy composition of embodiment 14, wherein the protein-enriched soy composition comprises one or more of (i) to (iii).
(i) less than or equal to about 1% crude fat on a dry weight basis as determined by petroleum ether extraction;
(ii) less than or equal to about 25% total dietary fiber on a dry weight basis; or
(iii) less than or equal to about 4% soluble dietary fiber on a dry weight basis.
   Embodiment 20. A protein-enriched texturized soy composition, comprising at least about 75% soy proteins on a dry weight basis, and a content of low molecular weight soluble dietary fiber is less than or equal to about 40% of the total soluble fiber content.
   Embodiment 21. A protein-enriched re-functionalized soy composition, comprising at least about 75% soy proteins on a dry weight basis, and a content of low molecular weight soluble dietary fiber is less than or equal to about 40% of the total soluble fiber content, wherein the protein-enriched re-functionalized soy composition has a protein dispersibility index of at least 70.
   Embodiment 22. A food product, a beverage product, a dietary supplement product or other product, comprising protein-enriched soy composition according to any one of embodiments 15-21.

### EXAMPLES

The presently disclosed subject matter will be better understood by reference to the following Examples, which are provided as exemplary of the invention, and not by way of limitation.

### Example 1: Process for Preparing Protein-Enriched Soy Compositions

High protein soybeans, with a protein content of about 48%, are first cleaned to remove foreign matter and loose hulls. The beans are then passed through driers to reduce their moisture content to approximately 10%-11% by weight, and are then tempered and stored for 1 to 5 days in order to facilitate dehulling.

The beans are then cracked using corrugated cracking rolls. The rolls crack each bean into four to six particles, and aspiration is used to remove the hulls.

The cracked beans are then conditioned using heat and steam, in order to make them pliable and facilitate flaking. The conditioned, cracked beans are then fed into smooth cylindrical rollers which press the beans into flakes, which vary in thickness from approximately 0.25 mm to 0.50 mm. Flaking allows the soybean oil cells to be exposed and the oil to be more easily extracted.

A hexane extraction process is then used to extract the oil from the flakes. The flakes are washed with hexane using a countercurrent extractor.

Following extraction, hexane is removed from the flakes via flash desolventizing under controlled times and temperatures to minimize protein denaturation. In order to remove the remaining hexane, the flakes are further processed by vacuum stripping with superheated steam under an approximately 0.5 barg vacuum to lower the remaining hexane concentration to 500 ppm. The flakes are then cooled to within 10 to 20° C. of ambient temperature by passing air through the material. The resulting flakes have a protein content of approximately 65%.

The resulting flakes are then washed with a polar solvent, such as water or alcohol (e.g., ethanol) or a mixture thereof, to remove soluble components. The removal of soluble components results in a concentrated soy composition having a higher protein content by weight. The concentrated soy composition are subsequently desolventized to remove the polar solvent, for example by dry heating, to provide a protein-enriched soy composition.

The protein-enriched soy composition is optionally subjected to further treatment to modify the functional properties-such as texturization by extrusion, or re-functionalization by hydrothermal (jet) cooking or by hydration and spray-drying.

### Example 2: Analytical Methods for Assessing Components and Properties of Protein Compositions

The present example describes exemplary analytical methods that may be used to characterize the composition and functionality of the protein-enriched soy compositions as provided herein.

### Protein

Protein content of a soy composition is measured using the Kjeldahl method (Wybraniec S., et. al. An overview of the Kjeldahl method of nitrogen determination. Part II. Sample preparation, working scale, instrumental finish and quality control. Crit. Rev. Anal. Chem. 2013; 43:224-272.). First, the sample to be analyzed is heated to 360-410° C. and digested using concentrated sulfuric acid in the presence of a catalyst, such as selenium or copper. Next, the pH of the solution is raised using sodium hydroxide in order to convert any ammonium (NH₄⁺) in solution (derived from nitrogen in the digested sample) in to ammonia gas (NH₃), which is then distilled off into an aqueous HCl solution of known volume and concentration. This solution may then be titrated in order to determine its pH, and back-calculate the amount of nitrogen in the original sample. The approximate percent weight of protein in a sample is calculated by multiplying the percent weight of nitrogen in the original sample by a factor of 6.25.

Protein content of a soybean, a batch of soybeans, or a soy composition may also be measured using near-infrared spectroscopy (NIRS). An overview of NIRS measurements is detailed in Zhu et al. Determination of soybean routine quality parameters using near-infrared spectroscopy. Food Sci. Nutr. 2018, 6, 1109-1118. Samples are placed in position relative to a light source and detector for an near-infrared spectrometer, such as a fourier-transform near-infrared spectrometer (FT-NIR) with a scanning spectral range of 3700-15,000/cm. Spectra are collected over the range 4000-12,600/cm, at a resolution of 16/cm with 60 scan number, which containing the absorbance regions of the traits of interest (4000-9000/cm for protein, moisture, and fat). Each sample is scanned three times to eliminate differences caused by objective factors. The spectra are compared to calibration or standard spectra, the protein content of which has been confirmed by wet laboratory methods, such as the Kjeldahl method.

### Amino Acids

The compositional profile of individual amino acids present in a soy composition may be determined according to AOAC 982.30. Three samples are taken and separately subjected to 1) acid hydrolysis; 2) acid oxidation followed by acid hydrolysis; and 3) alkaline hydrolysis. Aliquots of each sample are analyzed by an amino acid analyzer to determine the amino acid profile.

### Fats

Fat content of a soy composition is measured using the Soxhlet method (AOAC (1990) method 945.39). First, moisture is removed from the sample, and the desiccated sample is ground into a powder and weighed. Then, a Soxhlet extractor is employed to extract any lipids from the sample using petroleum ether. Once the lipids in a sample have been fully extracted, the sample is weighed again, and the difference in mass is used to determine the mass of lipids originally present in the sample.

Fat content of a soy composition may also be measured by acid hydrolysis according to AOAC 954.02. A ground sample of the soy composition is saturated with ethanol and hydrochloric acid to help release fat in the sample. The sample is placed in a heated water bath (75.5 degrees Celsius) for 40 minutes. The sample is removed from heat and allowed to cool to room temperature. The cooled sample is treated separately with ethyl ether and then petroleum ether to extract fat from the sample. The solvents are evaporated off and the solid content remaining from the extractions are weighed and recorded as “fat”.

### Ash

Ash content of a soy composition is measured using standard methods. A sample of the soy composition is first dried. Then, the sample is weighed. The sample is then placed in a crucible, and placed in a high temperature muffle furnace for a period of 24 hours at 500 to 600° C. in order to dry ash the sample. Once the sample has been ashed, the remaining solids are weighed in order to determine the weight percent of ash in the sample.

### Carbohydrates

The total carbohydrate content of a soy composition is measured by first calculating the protein, fat, and ash (mineral) content of a sample on a dry basis. The carbohydrate composition is the percent mass of the dry composition which is not accounted for by these four components.

### Fiber

Fiber content of a soy composition is measured using standardized methods (AOAC (1990) method 985.29). Wherein duplicate test portions of the sample are digested with enzymes (i) a-amylase, (ii) protease, (iii) amyloglucosidase. The residue is allowed to precipitate and is filtered. One residue goes for protein analysis, the other for ash analysis.

$$\text{Total dietary fiber} = \text{weight of the residue} - weight ( ash + protein ) .$$

### Insoluble Dietary Fiber and Soluble Dietary Fiber

The total dietary fiber of a soy composition may be further analyzed according to any suitable methods known in the art, to determine its profile of different categories of fiber and starch therein, including insoluble dietary fiber and soluble fiber.

### Total Sugar and Individual Mono-, Di- and Oligosaccharide Content

The total sugar and oligosaccharide content of a soy composition may also be analyzed according to any suitable methods known in the art.

### Stachyose

Stachyose content of a soy composition is measured using a high performance anion exchange chromatography coupled with pulsed amperometric detection (HPAEC-PAD) (AOAC 2001.02) method, wherein a buffered extract of the sample is treated with an enzyme, β-galactosidase, that hydrolyzes trans-galactooligosaccharides to galactose and glucose. Galactose and other sugars are separated on a high performance anion-exchange chromatography column and detected by pulsed amperometric detection (PAD) using a triple potential waveform.

### Raffinose

Raffinose content of a soy composition is measured using the standardized HPAEC-PAD method (AOAC 2001.02) or an HPLC method.

### Protein Dispersibility Index

Protein dispersibility index (PDI) of a soy composition is measured as follows: 20 g of a soy sample is weighed and blended. 300 mL deionized water is measured and 50 mL of the deionized water is added to the blended soy sample. The deionized water and blended soy sample are stirred to form a paste. The remaining 250 mL of deionized water is added to the paste, and the remaining deionized water and paste are blended at 8500 rpm for 10 minutes. After 10 minutes, the blended mixture is centrifuged at 2700 rpm for 10 minutes. The supernatants from the centrifuged samples are collected and weighed. The protein content of the supernatant is determined relative to the protein content of the original soy sample, and the PDI is calculated as the percentage of the protein in the supernatant divided by the percentage in the original soy sample (a PDI of 100 indicates total solubility).

### Gel Electrophoresis

The protein profile of a soy composition, to determine the presence of certain soy proteins and/or other enzymes, such as LOX, may be assessed by gel electrophoresis, including sodium decyl sulfate-polyacrylamide gel electrophoresis (SDS-PAGE). Any suitable methods known in the art for preparing and analyzing samples with SDS-PAGE may be employed.

### Foaming Capacity and Stability

The foaming properties of a soy composition are measured as generally described by Boyle (Boyle, C., Hansen, L., Hinnenkamp, C. and Ismail, B. P. (2018), Emerging Camelina Protein: Extraction, Modification, and Structural/Functional Characterization. J Am Oil Chem Soc, 95: 1049-1062.).

Foaming capacity may determined as follows: triplicate protein dispersions are prepared at 0.5% w/w, 200 mL water. The pH of the dispersions is adjusted to 7.0 as needed. The dispersions are stirred for 2 hours at 420 rpm. 50 g of each dispersion sample is blended at 800-900 rpm for 2 minutes. The blended samples are poured into a graduated cylinder, and the total volume, as well as the individual volumes of the liquid portion and foam portion are measured. The blended samples are allowed to stand for 30 minutes, and the total volume and individual volumes of the liquid portion and foam portion, are measured after 30 minutes have elapsed. The foam capacity is determined by measuring the foam volume after whipping. The liquid percentage is determined by measuring the liquid that was not incorporated into the foam system.

$$Foaming Capacity = Total solution volume - liquid volume / ( grams of protein ) . \qquad Eq . 2$$

Foaming stability is determined as the foam volume that remained for 30 min at room temperature:

$$Foam stability ( \% ) = [ Total solution {volume}_{30 mins} - liquid {volume}_{30 m i n} ] / [ Total solution {volume}_{0 m i n} - liquid {volume}_{0 m i n} ] * 100 \qquad Eq . 3$$

### Viscosity

Viscosity of a soy composition is measured as follows: a soy sample is weighed and mixed with a certain volume of water to a specific dry solid concentration. The mixture is placed in a suitable container for analysis by a viscometer. The mixture is subjected to a temperature ramp program and stirring program as follows: start at 25° C. for 5 min, increases to 95° C. at the rate of 12° C./min, hold at 95° C. for 6 min, cool down from 95° C. at the rate of 12° C./min; stir at 960 rpm for 1 min and decrease to 160 rpm.

### Water Holding Capacity

Water holding capacity of a soy composition is measured using the AACC Approved Methods of Analysis AACC 56-30.1 (“Water hydration capacity of protein materials”); and/or AACC 56-37.01 (“Water holding capacity of pulse flours and protein materials”). The water holding capacity may be determined as the powder water holding capacity or the gel water holding capacity.

For power water holding capacity: a pre-weighed sample of soy composition is mixed with distilled water and transferred to a tared centrifuge tube. The slurried sample is allowed to rest for 30 minutes to allow for full hydration of the protein; during this period, the sample is vortexed for 30 seconds at 10-minute intervals. The centrifuge tube with the slurried sample is weighed. The slurried sample is then centrifuged at 2000-5000×g for 10 minutes at 25° C. If no supernatant appears, an additional 5 mL of distilled water is added to the centrifuge tube, and the steps of resting, vortexing, and centrifugation are repeated, with additional water added until a supernatant appears. The supernatant is discarded and the remaining sediment in the tube is weighed.

The water holding capacity (WHC) is calculated as follows:

$$WHC ( \text{g/g} ) = [ ( weight of last sediment - original sample weight ) * ( 1 - moisture content \% ) ] / [ original sample weight * ( 1 - moisture content \% ) ] . \qquad Eq . 4$$

For gel water holding capacity, a soy composition may be analyzed according to the water holding capacity protocol as generally described in Ismail, B. P. (2018), Emerging Camelina Protein: Extraction, Modification, and Structural/Functional Characterization. J Am Oil Chem Soc, 95: 1049-1062.

### Oil Holding Capacity

Oil holding capacity of a soy composition is measured as generally described in by Brishti (Brishti, F. H., Zarei, M. et al. International Food Research Journal 24(4): 1595-1605 (August 2017). Evaluation of the functional properties of mung bean protein isolate for development of textured vegetable protein.): 1 g (or 2.5 g) of soy sample is weighed in a tared centrifuge tube. 10 g (or 20 g) of soybean oil is added and homogenized for 2 minutes Samples are left at room temperature for 30 minutes to allow protein to fully bind the oil. During the 30-minute period, the sample is further mixed for 30 seconds in a vortex mixer, at 15-minute intervals. The mixture is then centrifuged at 5000 g for 30 minutes. The supernatant oil is decanted and the new mass of the remaining sediment of the sample recorded, wherein the oil holding capacity (OHC) is calculated as the difference of the oily sediment after centrifugation and the dry soy sample, divided by the weight of the dry sample:

$$OHC = ( {mass}_{oiled} - {mass}_{dry} ) / {mass}_{dry} \qquad Eq . 5$$

### Emulsification Properties

The emulsification activity and stability of a soy composition may be measured spectrophotometrically as described below.

A protein solution of 0.1-0.25% protein content is prepared with the soy sample. The solution is stirred until completely solubilized. The pH of the protein solution is adjusted to pH 9.5, and the sample is placed in a refrigerator overnight at 4° C. A standard solution of 0.1% SDS (1 g SDS to 1000 mL of deionized water) is prepared and placed in a spectrophotometry cuvette. The spectrophotometer is set to detection wavelength 500 nm and the standard solution of 0.1% SDS is used as a blank.

After storage overnight, 12.5 mL of corn oil and 37.5 mL of protein solution are combined in a beaker. The mixture is homogenized at 13,000 rpm for 2 minutes, and allowed to stand for 1 minute after homogenization. 0.5 mL of homogenized liquid is pipetted from the bottom of the beaker and mixed with 50 mL of 0.1 SDS standard solution. The mixture is placed in a sample cuvette, and the sample cuvette placed into the spectrophotometer. Absorbance is measured to give an initial absorbance A₀. After ten minutes, a second sample cuvette is prepared with 0.5 mL of homogenized liquid from the bottom of the beaker and mixed with 50 mL of 0.1 SDS standard solution. The second sample cuvette is placed into the spectrophotometer and a second absorbance measurement A₁₀ is taken.

The emulsification activity and emulsification stability are calculated as follows:

$$Emulsion Activity = 2 * 2.303 * \frac{A 0 \times D}{C \times ( 1 - φ ) \times 1 {0}^{4}} \qquad Eq . 6$$

$$Emulsion Stability : \frac{{A}_{0}}{{A}_{0} - {A}_{10}} * 10 \qquad Eq . 7$$

wherein A₀ and A₁₀ represent the absorbance at 0 and 10 min, respectively. D is dilution factor (100), C is the protein concentration (0.001 g/mL), φ is the volume fraction of corn oil (0.25).

Alternatively, the emulsion stability and activity of a soy composition may be measured according to the protocol as generally described by Ismail, B. P. (2018), Emerging Camelina Protein: Extraction, Modification, and Structural/Functional Characterization. J Am Oil Chem Soc, 95: 1049-1062.

### Emulsification Capacity

The emulsion capacity of a soy composition may be measured according to the protocol as generally described in Ismail, B. P. (2018), Emerging Camelina Protein: Extraction, Modification, and Structural/Functional Characterization. J Am Oil Chem Soc, 95: 1049-1062.

### Minimum Gelling Concentration

The minimum gelling concentration of a soy composition is measured using the Least Gelatinization Concentration (LGC). The method is conducted as follows: various sample suspensions (40 mL) are prepared in test tubes at concentrations of 5%, 7.5%, 10%, 12.5%, 15%, 17.5, and 20%. The pH is adjusted to 7.0 and the suspensions are stirred for 1 hour at room temperature. The suspensions are then heated at 95° C. for 30 minutes, and allowed and cooled to room temperature. The suspensions are refrigerated overnight at 4° C. The suspensions are removed form the refrigerator and visually evaluated for observable movement when inverted. The minimum gelling concentration is the concentration at which the sample does not fall from the inverted test tube.

Alternatively, the minimum gelling concentration of a soy composition may be measured according to the protocol as generally described in Ismail, B. P. (2018), Emerging Camelina Protein: Extraction, Modification, and Structural/Functional Characterization. J Am Oil Chem Soc, 95: 1049-1062.

### Gelling Strength

Gelling strength of a soy composition is measured using AACC Approved Methods of Analysis 54-10.01 Extensigraph Method.

Alternatively, the gelling strength of a soy composition may be measured according to the protocol as generally described in Ismail, B. P. (2018), Emerging Camelina Protein: Extraction, Modification, and Structural/Functional Characterization. J Am Oil Chem Soc, 95: 1049-1062.

### Bulk Density

Bulk density of a soy composition is measured as follows: a beaker marked with a pre-determined volume marked on its external surface is tared. A soy sample is added to the beaker to the pre-determined volume. The weight of the soy sample is measured, and the bulk density is calculated as the weight of the soy sample divided by the volume as follows:

$$Bulk density ( \text{g/L} ) = sample weight / ( predetermined volume ( mL ) / 1000 ) \qquad Eq . 8$$

### Texture Properties

Texture properties of a soy composition, such as hardness, adhesiveness, cohesiveness, brittleness, elastic quality, gumminess and chewiness may be evaluated with a texture analyzer and suitable attachments.

A soy sample is prepared for texture analysis as follows: the soy sample is screened through a screen with mesh #4 and retained on a screen with mesh #5 in order to obtain suitable particulate sample size. 100 g of the screened sample material is weighed and mixed with 1000 g of distilled water. The screened sample material and water are allowed to sit for 1 hour at ambient temperature. The water is drained from the soaked sample material, and the soaked sample material is drained and screened on a screen with mesh #12. The hydrated solids retained on the mesh screen with mesh #12 are covered for 30 minutes. The hydrated solids are weighed. The water absorption capacity is determined by determining the amount of water absorbed per 100 gram of soy sample:

$$\text{Water absorption capacity} ( \text{g/} 100 g ) = ( \text{weight of \#12 screen and hydrated} TVP - \text{the screen weight} - 70 ) / 70 ( \text{g/} 100 g ) \qquad Eq . 9$$

The hydrated solids are collected for texture analysis and the water drained from the hydrated solids are retained to determine solid content and to calculate dry matter loss from the initial soy sample during soaking.

The hydrated solids are weighed (approximately 70 g) and placed into Kramer shear cell. The sample in the cell is shaken to ensure even distribution and secure sealing of the cell. The cell is fitted and aligned onto the texture analyzer fitted with the blade for the Kramer shear cell. The plunger speed is set to 10 mm/s, the trigger force at 10 g, and the compressing distance at 61 mm. The maximal force applied to the sample in the Kramer shear cell is recorded to determine firmness.

The water drained from the hydrated solids (“soaking water”) can be evaluated for solid content in order to determine dry matter loss from the initial soy sample. 10 g of the drained water is collected into a suitable container and oven-dried at 50° C. overnight. The dried sample remaining in the container is placed in a desiccator for 1 hour. After 1 hour, the weight of the dried sample is recorded. The solid content of the soaking water is calculated as follows:

$$Solid content ( \% ) = weight of dried sample / weight of soaking water in moisture pan ( \% ) . \qquad Eq . 10$$

The dry matter loss from the initial soy sample can be further calculated as follows:

$$Dry matter loss ( \% ) = ( weight of soaking water collected \times solid content of soaking water / 70 ( \% ) \qquad Eq . 11$$

### Genetic Analysis

Soy compositions as provided herein may be subjected to genetic analysis in order to identify genetic markers or fragments associated with certain characteristics that may be present in the source soybeans. Any suitable methods known in the art for genetic analysis of soy compositions may be used, including, for example, Stefanova et al. (2013) “A Modified CTAB Method for DNA Extraction from Soybean and Meat Products”, Biotechnology & Biotechnological Equipment, 27:3, 3802-3810.; Du et al. (2020) “Monitoring and traceability of genetically modified soya bean event GTS 40-3-2 during soya bean protein concentrate and isolate preparation” R. Soc. Open Sci, 7: 201147; Koh, Chem Lin. 2012. (thesis) Evaluation ofDna Recovery Methods for the Detection of Soy In Foods Using Real-Time Pcr.: Oregon State University.

### Example 3: Composition Analysis of Exemplary Protein-Enriched Soy Compositions

The present example details the composition of three samples of protein-enriched soy compositions prepared in accordance with the protocol detailed in Example 1. The table below shows the composition of the protein-enriched soy composition samples obtained from ethanol washing of white flakes.

| | Trial #1 | | Trial #2 | | Trial #3 | |
|---|---|---|---|---|---|---|
| | Defatted | | Defatted | | Defatted | |
| | desolventized | | desolventized | | desolventized | |
| | soybean | | soybean | | soybean | |
| Component (% | composition | Protein- | composition | Protein- | composition | Protein- |
| on dry weight | (White | Enriched Soy | (White | Enriched Soy | (White | Enriched Soy |
| basis) | Flake) #1 | Composition #1 | Flake) #2 | Composition #2 | Flake) #3 | Composition #3 |
| Protein content | 62.3 | 74.3 | 63.4 | 77.8 | 62.0 | 75.3 |
| Ash | 6.2 | 5.7 | 6.9 | 6.3 | 7.2 | 7.0 |
| Crude Fat | 1.0 | 0.7 | 0.6 | 0.3 | 0.7 | 0.6 |
| Crude Fiber | 4.5 | 6.6 | 3.1 | 4.2 | 3.8 | 4.3 |
| LMWSDF | 2.1 | 1.1 | 6.7 | 1.2 | 2.0 | 0.8 |
| HMWSDF | 2.6 | 2.2 | 1.4 | 1.9 | 1.7 | 2.3 |
| IDF | 17.6 | 21.5 | 14.0 | 17.4 | 15.7 | 19.6 |
| SDF | 4.9 | 3.3 | 8.2 | 3.1 | 3.8 | 3.1 |
| Total dietary | 22.5 | 24.8 | 22.2 | 20.5 | 19.4 | 22.7 |
| fiber | | | | | | |
| Raffinose | 0.4 | 0.0 | 1.0 | 0.0 | 0.2 | 0.0 |
| Stachyose | 0.4 | 0.5 | 5.5 | 0.5 | 0.5 | 0.0 |
| Fructose | 0.3 | 0.0 | 0.3 | 0.0 | 0.2 | 0.0 |
| Glucose | 0.0 | 0.0 | 0 | 0.0 | 0.0 | 0.0 |
| Sucrose | 12.0 | 0.0 | 5.7 | 0.0 | 8.3 | 0.0 |
| Maltose | 0.0 | 0.0 | 0.0 | 0.0 | 0.0 | 0.0 |
| Lactose | 0.0 | 0.0 | 0.0 | 0.0 | 0.0 | 0.0 |
| Total sugar | 12.3 | 0.4 | 5.95 | 0.0 | 8.5 | 0.4 |
| Tryptophan | 0.9 | 1.0 | 0.9 | 1.1 | 0.9 | 1.1 |
| Alanine | 2.5 | 3.2 | 2.7 | 3.0 | 2.7 | 3.3 |
| Arginine | 4.4 | 6.4 | 4.9 | 5.3 | 4.5 | 5.6 |
| Aspartic acid | 6.7 | 8.6 | 7.5 | 8.3 | 7.4 | 9.0 |
| Glutamic acid | 10.9 | 14.1 | 12.3 | 13.6 | 12 | 14.6 |
| Glycine | 2.5 | 3.2 | 2.7 | 3.0 | 2.6 | 3.2 |
| Histidine | 1.6 | 1.9 | 1.6 | 1.8 | 1.6 | 2.0 |
| Isoleucine | 2.7 | 3.3 | 2.9 | 3.2 | 2.9 | 3.6 |
| Leucine | 4.5 | 5.8 | 4.9 | 5.6 | 4.9 | 6.2 |
| Phenylalanine | 3.0 | 3.8 | 3.3 | 3.7 | 3.3 | 4.1 |
| Proline | 2.9 | 3.8 | 3.3 | 3.7 | 3.2 | 3.9 |
| Serine | 2.9 | 3.9 | 3.3 | 3.7 | 3.2 | 4.1 |
| Threonine | 2.3 | 2.9 | 2.5 | 2.8 | 2.4 | 3.1 |
| Lysine | 3.7 | 4.7 | 4.1 | 4.5 | 3.9 | 4.7 |
| Tyrosine | 1.9 | 2.4 | 2.1 | 2.4 | 2.1 | 2.7 |
| Valine | 2.9 | 3.6 | 3.0 | 3.4 | 3.1 | 3.7 |
| Cysteine | 0.8 | 0.8 | 0.8 | 0.9 | 0.8 | 0.8 |
| Methionine | 0.9 | 0.9 | 0.9 | 1.1 | 0.8 | 1.0 |

Essential amino acids are in bold text
LMWSDF: low molecular weight soluble dietary fiber
HMWSDF: high molecular weight soluble dietary fiber
IDF: insoluble dietary fiber
SDF: soluble dietary fiber; SDF = LMWSDF + HMWSDF
Total dietary fiber = IDF + SDF

### Example 4: Environmental Footprint Assessment of Exemplary Soy Compositions

The environmental impact of soy protein products prepared from high-protein soy beans is assessed. Additionally, the resources consumed during the processing to prepare the products are also calculated. As a benchmark, the same calculations are performed for analogous products prepared using commodity soybeans.

The protein content, water use, electricity use, and carbon footprint of the products are calculated. The total carbon footprint and the processing carbon footprint are calculated separately.

Water use reflects the total amount of water withdrawn from its source and which might return to a watershed, as for instance in the case of cooling water in a power plant or in the case of evaporation, after it has been used in a process.

Electricity use is defined as the total amount of electricity consumed during and as a direct result of any processes necessary to transform the soybeans into the specified product (e.g., soybean meal, soy white flakes, soy flour, soy protein concentrate, or soy protein isolate).

The total carbon footprint reflects the carbon footprint of the respective product, including cultivation of the soybeans, transportation of the soybeans, and processing of the soybeans, up to the factory gate. This carbon footprint includes CO₂ released during cultivation of the soy due to emissions from agricultural machinery, CO₂ released during the production of any pesticides and synthetic fertilizers used when growing the soybeans, CO₂ released as emissions during transport of the soy to the processing location, emissions contributed as a result of any electricity or heat used during processing of the soybeans, and any CO₂ emissions related to land use change.

The processing carbon footprint reflects the carbon footprint associated only with the processing of the soybeans into the specified product (e.g., soybean meal, soy white flakes, soy flour, soy protein concentrate, or soy protein isolate). This carbon footprint does not include CO₂ emissions associated with the cultivation or transportation of the soybeans. This carbon footprint includes any electricity or heat used during processing. It also includes CO₂ released during the production of any additives used in processing (e.g., hexane), as well as CO₂ released during the processing of any wastewater generated during the processing step.

Reference to “about” a value or parameter herein includes (and describes) embodiments that are directed to that value or parameter per se. For example, description referring to “about X” includes description of “X”. In some embodiments, the term “about” when used in association with a measurement, or used to modify a value, a unit, a constant, or a range of values, refers to variations of +/−2%.

Reference to “between” two values or parameters herein includes (and describes) embodiments that include those two values or parameters per se. For example, description referring to “between x and y” includes description of “x” and “y” per se.

It is understood that aspects and variations described herein also include “consisting” and/or “consisting essentially of” aspects and variations.

1. A method of producing a protein-enriched soy composition, the method comprising:
a) providing soybeans having a high protein content;
b) defatting the soybeans by solvent extraction to produce a defatted soybean composition;
c) desolventizing the defatted soybean composition to directly produce a defatted desolventized soybean composition that comprises at least about 60% soy proteins on a dry weight basis;
d) contacting the defatted desolventized soybean composition with polar solvent to remove soluble components to produce a concentrated soy composition, and
e) desolventizing the concentrated soy composition to produce a protein-enriched soy protein composition that comprises at least about 75% soy proteins on a dry weight basis.

2. The method of claim 1, wherein at least a portion of the soybeans has a protein content of at least about 42% soy proteins on a dry weight basis.

3. The method of claim 1, wherein:
(i) the method uses less water per ton of protein-enriched soy protein composition than a composition with the same protein content prepared using commodity soybeans; or
(ii) the method uses less electricity per ton of protein-enriched soy protein composition than a composition with the same protein content prepared using commodity soybeans; or
(iii) the method results in the release of less CO₂ into the atmosphere per ton of protein-enriched soy protein composition than a composition with the same protein content prepared using commodity soybeans; or
any combination of (i)-(iii) above.

4. The method of claim 1, wherein providing soybeans having a high protein content comprises:
(i) cultivating soybeans;
(ii) harvesting the soybeans; and
(iii) transporting the soybeans from a harvesting location to a processing location.

5. The method of claim 1, wherein the polar solvent comprises alcohol or water, or a mixture thereof.

6. The method of claim 1, wherein the alcohol is ethanol.

7. The method of claim 1, wherein the polar solvent does not contain alcohol.

8. The method of claim 1, wherein at least a portion of the soybeans provided in step a) has a protein content of at least about 45% soy proteins on a dry weight basis.

9. The method of claim 1, wherein at least a portion of the soybeans provided in step a) has a protein content of at least about 48% soy proteins on a dry weight basis.

10. The method of claim 1, wherein the method further comprises dehulling the soybeans, and optionally mechanically flaking or grinding the dehulled beans, prior to the defatting step.

11. The method of claim 1, wherein the method further comprises flaking the soybeans prior to the defatting step.

12. The method of claim 1, wherein the soy protein composition comprises one or more of (i) to (iv):
(i) less than or equal to about 1% crude fat on a dry weight basis as determined by petroleum ether extraction;
(ii) less than or equal to about 25% total dietary fiber on a dry weight basis;
(iii) less than or equal to about 4% soluble dietary fiber on a dry weight basis; or
(iv) a content of low molecular weight soluble dietary fiber less than or equal to about 40% of the total soluble dietary fiber present.

13. The method of claim 1, wherein the protein-enriched soy composition produced has one or more improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, and higher concentration of steric acid, or any combination thereof, as compared to a soy protein concentrate or soy protein isolate produced from commodity soybeans.

14. The method of claim 1, wherein the protein-enriched soy composition produced has a reduced quantity of lipoxygenase enzyme as compared as compared to a soy protein concentrate or soy protein isolate produced from commodity soybeans, as determined by SDS-PAGE.

15. The method of claim 1, further comprising extruding the protein-enriched soy composition produced to provide a protein-enriched texturized soy composition.

16. The method of claim 1, further comprising hydrothermally cooking the protein-enriched soy composition produced, and drying the cooked protein-enriched soy composition to provide a protein-enriched re-functionalized soy composition.

17. The method of claim 16, wherein the protein-enriched re-functionalized soy composition produced has a protein dispersibility index of at least 70.

18. A protein-enriched soy composition produced according to the method of claim 1.

19. A protein-enriched texturized soy composition produced according to the method of claim 15.

20. A protein-enriched re-functionalized soy composition produced according to the method of claim 16.

21. A protein enriched soy composition, comprising at least about 75% soy proteins on a dry weight basis, produced according to a process that:
(i) uses less water per ton of protein-enriched soy protein composition than a composition with the same protein content prepared using commodity soybeans; or
(ii) uses less electricity per ton of protein-enriched soy protein composition than a composition with the same protein content prepared using commodity soybeans; or
(iii) results in the release of less CO₂ into the atmosphere per ton of protein-enriched soy protein composition than a composition with the same protein content prepared using commodity soybeans; or
any combination of (i)-(iii) above.

22. The protein-enriched soy composition, of claim 21, comprising a content of low molecular weight soluble dietary fiber that is less than or equal to about 40% of the total soluble fiber content.

23. The protein-enriched soy composition of claim 21, wherein the protein-enriched soy composition comprises one or more of (i) to (iii).
(i) less than or equal to about 1% crude fat on a dry weight basis as determined by petroleum ether extraction;
(ii) less than or equal to about 25% total dietary fiber on a dry weight basis; or
(iii) less than or equal to about 4% soluble dietary fiber on a dry weight basis.

24. A protein-enriched texturized soy composition, comprising at least about 75% soy proteins on a dry weight basis, and a content of low molecular weight soluble dietary fiber is less than or equal to about 40% of the total soluble fiber content.

25. A protein-enriched re-functionalized soy composition, comprising at least about 75% soy proteins on a dry weight basis, and a content of low molecular weight soluble dietary fiber is less than or equal to about 40% of the total soluble fiber content, wherein the protein-enriched re-functionalized soy composition has a protein dispersibility index of at least 70.

26. A food product, a beverage product, a dietary supplement product or other product, comprising protein-enriched soy composition according to claim 18.
